(19) United States
(12) Patent Application Publication
(10) Pub. No.: US 2008/0285490 A1
(43) Pub. Date: Nov. 20, 2008

(54) RADIO COMMUNICATION SYSTEM, TERMINAL APPARATUS AND BASE STATION APPARATUS

(76) Inventors: Manabu MUKAI, Yokohama-shi (JP); Tomoya Horiguchi, Kawasaki-shi (JP); Takeshi Tomizawa, Kawasaki-shi (JP); Kaoru Inoue, Machida-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/175,505

(22) Filed: Jul. 18, 2008

Related U.S. Application Data
(62) Division of application No. 11/072,616, filed on Mar. 7, 2005.

(30) Foreign Application Priority Data
Mar. 31, 2004 (JP) 2004-102500

(51) Int. Cl. H04L 5/12; H04B 1/713

(52) U.S. Cl. 370/280

(57) ABSTRACT

A radio communication system which includes a base station apparatus and terminal apparatuses and performs TDD two-way communications using an OFDM signal including subcarriers in a downstream communication from the base station apparatus to each terminal apparatus, and an FH signal having the same frequency band as that of the subcarriers in an upstream communication from the each terminal apparatus to the base station apparatus, the each terminal apparatus estimates transmission channel characteristics of the subcarriers based on the OFDM signal received, transmits an estimation result of the estimation unit to the base station apparatus, and the base station apparatus assigns, to the each terminal apparatus, at least one of subcarriers to be used in the downstream communication of the subcarriers and a hopping pattern to be used in the upstream communication, based on the estimation result transmitted from the each terminal apparatus.

### CROSS-REFERENCE TO RELATED APPLICATIONS

This application is a divisional of and claims the benefit of priority from U.S. Ser. No. 11/072,616, filed Mar. 7, 2005, which claims the benefit of priority from prior Japanese Patent Application No. 2004-102500, filed Mar. 31, 2004, the entire contents of each of which are incorporated herein by reference.

### BACKGROUND OF THE INVENTION

1. Field of the Invention

Most of conventional radio communication systems that make two-way communications between a base station and terminal use symmetric up and down radio links that use the same modulation method in upstream and downstream communications (e.g., see Jpn. Pat. Appln. KOKAI Publication No. 2000-299681).

2. Description of the Related Art

As one of modulation methods that implements high-speed data transfer, OFDM is known. A signal modulated by OFDM includes a plurality of subcarriers, has a broad dynamic range as a time waveform, and requires a transmission power amplifier to have linearity. When a signal is transmitted using OFDM, large power consumption is inevitably required. Therefore, when OFDM is applied to a conventional radio communication system to realize a high-speed down channel (from a base station to a terminal), the same bandwidth and modulation method (OFDM) are used in an up channel (from the terminal to the base station), thus requiring large power consumption of the terminal.

Some of conventional radio communication systems that make two-way communications between a base station and terminal have different bandwidths of up and downstream communications and different radio frequency bands used in up and downstream communications (e.g., see Jpn. Pat. Appln. KOKAI Publication No. 7-176791). In such radio communication system that uses asymmetric up and down radio links, since different radio frequencies are used in up and downstream communications, the characteristics of a transmission channel cannot be accurately estimated. Therefore, techniques such as transmission power control, directivity control, adaptive modulation, and the like cannot be effectively used, thus deteriorating the radio channel quality.

In this way, the conventional radio communication system that uses asymmetric up and down radio links can speed up a downstream communication and can reduce power consumption of the terminal. However, since up and downstream communications use different radio frequencies, the characteristics of a transmission channel cannot be accurately estimated, resulting in poor communication quality of up and downstream communications.

Hence, the present invention has been made in consideration of the above problems, and has as its object to provide a radio communication system, terminal apparatus, and base station apparatus which use asymmetric up and down radio links that allow high-quality communications between the base station and terminal.

As described above, in a radio communication system which uses an OFDM (Orthogonal Frequency Division Multiplexing) signal including a plurality of subcarriers in a downstream communication from the base station to the terminal, and an FH (Frequency Hopping) signal with the same frequency band as that of the OFDM signal in an upstream communication from the terminal to the base station, and makes two-way communications based on TDD (Time Division Duplex), the terminal estimates the transmission characteristics (at least one of power, power ratio, and phase and amplitude distortions) of the plurality of subcarriers on the basis of the received OFDM signal, and transmits the estimation result to the base station. The base station assigns, to the terminal, at least one of a subcarrier used in the downstream communication of the plurality of subcarriers and a hopping pattern used in the upstream communication.

In the downstream communication, since transmission is made using full bandwidth of the plurality of subcarriers, the terminal can adequately measure the state of the transmission channel between the terminal and base station. The base station preferentially selects an optimal subcarrier to the terminal on the basis of the measurement result, and assigns a hopping pattern used in the upstream communication or a subcarrier used in the downstream communication, thus allowing high-quality communications between the base station and terminal.

Also, in a radio communication system which uses an OFDM (Orthogonal Frequency Division Multiplexing) signal including a plurality of subcarriers in a downstream communication from the base station to the terminal, and an FH (Frequency Hopping) signal with the same frequency band as that of the OFDM signal in an upstream communication from the terminal to the base station, and makes two-way communications based on TDD (Time Division Duplex), the base station estimates the transmission channel characteristics between the terminal and base station on the basis of a signal transmitted from the terminal in a time slot of the upstream communication, and assigns at least one of a subcarrier used in the downstream communication of the plurality of subcarriers, and a hopping pattern used in the upstream communication, to each terminal on the basis of the estimation result.

When the base station receives the FH signal or OFDM signal that uses the full bandwidth of the plurality of subcarriers transmitted from the terminal in the upstream communication, it can adequately measure the state of the transmission channel between the terminal and base station. The base station preferentially selects an optimal subcarrier to the terminal on the basis of the measurement result, and assigns a hopping pattern used in the upstream communication or a subcarrier used in the downstream communication, thus allowing high-quality communications between the base station and terminal.

### BRIEF SUMMARY OF THE INVENTION

The present invention relates to a radio communication system which uses OFDM in a downstream communication and FH in an upstream communication.

According to embodiments of the present invention, there is provided a radio communication system which includes a base station apparatus and terminal apparatuses and performs TDD (Time Division Duplex) two-way communications using an OFDM (Orthogonal Frequency Division Multiplexing) signal including all or some of a plurality of subcarriers in a downstream communication from the base station apparatus to each of the terminal apparatuses, and an FH (Frequency Hopping) signal having the same frequency band as that of the subcarriers in an upstream communication from the each of the terminal apparatuses to the base station apparatus, the each of the terminal apparatuses estimates transmission channel characteristics of the subcarriers based on the OFDM signal received; and transmits an estimation result of the estimation unit to the base station apparatus, and the base station apparatus assigns, to the each of the terminal apparatuses, at least one of subcarriers to be used in the downstream communication of the subcarriers and a hopping pattern to be used in the upstream communication, based on the estimation result transmitted from the each of the terminal apparatuses.

### BRIEF DESCRIPTION OF THE SEVERAL VIEWS OF THE DRAWING

FIG. 1 is a view illustrating an example of a schematic arrangement of a whole radio communication system according to the first embodiment;

FIG. 2 is a view illustrating an example of a schematic arrangement of the whole radio communication system according to the first embodiment;

FIG. 3 is a view illustrating an example of a schematic arrangement of the whole radio communication system according to the first embodiment;

FIG. 4 is a view for explaining a case wherein TDD communications are made using an identical frequency band in up and down links;

FIG. 5 is a view for explaining a case wherein signals of a plurality of users are multiplexed in the down link;

FIG. 6 is a view for explaining a case wherein transmission power control, FH hopping pattern control, and the like are made using the transmission channel characteristics estimated by each terminal that receives an OFDM signal transmitted via the down link;

FIG. 7 is a flowchart for explaining the processing operations of the terminal and base station when transmission power control, FH hopping pattern control, and the like are made using the transmission channel characteristics estimated by each terminal that receives an OFDM signal transmitted via the down link;

FIG. 8 is a view for explaining a case wherein two-way communications (FDD) are realized using different frequencies in an OFDM up link and FH up link;

FIG. 9 shows the format of a first slot;

FIG. 10 shows the format of a second slot;

FIG. 11 shows the format of a third slot;

FIG. 12 shows the format of a fourth slot;

FIG. 13 shows the format of a fifth slot;

FIG. 14 shows the format of a sixth slot;

FIG. 15 shows the format of a seventh slot;

FIG. 16 shows the format of an eighth slot;

FIG. 17 shows the format of a ninth slot;

FIG. 18 is a block diagram showing an example of the arrangement of a base station;

FIG. 19 is a block diagram showing an example of the arrangement of a terminal;

FIG. 20 shows a slot format applied to a radio communication system according to the second embodiment;

FIG. 21 is a block diagram showing an example of the arrangement of a base station according to the second embodiment;

FIG. 22 is a block diagram showing an example of the arrangement of a terminal according to the second embodiment;

FIG. 23 shows a slot format applied to a radio communication system according to the third embodiment;

FIG. 24 is a block diagram showing an example of the arrangement of a base station according to the third embodiment;

FIG. 25 is a block diagram showing an example of the arrangement of a terminal according to the third embodiment;

FIG. 26 shows a slot format applied to a radio communication system according to the fourth embodiment of the present invention;

FIG. 27 is a block diagram showing an example of the arrangement of a base station according to the fourth embodiment;

FIG. 28 is a block diagram showing an example of the arrangement of a terminal according to the fourth embodiment;

FIG. 29 is a flowchart for explaining the processing sequence for changing the communication speed ratio between a base station and terminal in a radio communication system according to the fifth embodiment;

FIG. 30 is a view for explaining a state wherein a slot format changes;

FIG. 31 is a block diagram showing an example of the arrangement of a base station according to the fifth embodiment;

FIG. 32 is a block diagram showing an example of the arrangement of a terminal according to the fifth embodiment;

FIG. 33 shows a slot format applied to a radio communication system according to the sixth embodiment;

FIG. 34 is a block diagram showing an example of the arrangement of a base station according to the sixth embodiment;

FIG. 35 is a block diagram showing an example of the arrangement of a terminal according to the sixth embodiment;

FIG. 36 shows another slot format applied to the radio communication system according to the sixth embodiment;

FIG. 37 shows a slot format applied to a radio communication system according to the seventh embodiment;

FIG. 38 is a block diagram showing an example of the arrangement of a base station according to the seventh embodiment;

FIG. 39 is a flowchart for explaining the control process between a base station and terminal using initial and terminal symbols (known pilot signals in the base station and terminal) in a down slot;

FIG. 40 is a flowchart for explaining the control process between a base station and terminal using initial and terminal symbols (known pilot signals in the base station and terminal) in a down slot in a radio communication system according to the eighth embodiment;

FIG. 41 is a view illustrating an example of a schematic arrangement of a whole radio communication system according to the ninth embodiment;

FIG. 42 shows the allocation of signals on the time and frequency axes in a down slot;

FIG. 43 shows the allocation of signals on the time and frequency axes in an up slot;

FIG. 44 is a flowchart for explaining the processing operation using known signals of a base station and terminal in a communication system according to the ninth embodiment;

FIG. 45 is a view for explaining an example of a method of assigning frequency bands and time regions (user channels) in up and down slots to respective terminals;

FIG. 46 is a view for explaining an example of a method of assigning frequency bands and time regions (user channels) in up and down slots to respective terminals;

FIG. 47 is a view for explaining another example of a method of assigning frequency bands and time regions (user channels) in up and down slots to respective terminals;

FIG. 48 is a view for explaining still another example of a method of assigning frequency bands and time regions (user channels) in up and down slots to respective terminals;

FIG. 49 is a block diagram showing an example of the arrangement of a transmission system of a terminal in a radio communication system according to the ninth embodiment;

FIG. 50 is a block diagram showing another example of the arrangement of a transmission system of a terminal in a radio communication system according to the ninth embodiment;

FIG. 51 is a view for explaining a hopping pattern of sequential hopping;

FIG. 52 is a view for explaining a hopping pattern of random hopping;

FIG. 53 is a view for explaining a hopping pattern of slide hopping;

FIG. 54 is a flowchart for explaining the processing operation of a base station for assigning a user channel in a down link using an FH signal transmitted from a terminal in a radio communication system according to the 10th embodiment;

FIG. 55 is a flowchart for explaining a channel assignment processing operation of the base station;

FIG. 56 is a view showing the processes executed until a channel in a down link is assigned to each terminal using an FH signal transmitted from the terminal;

FIG. 57 is a view showing the processes executed until a channel in a down link is assigned to each terminal using an FH signal transmitted from the terminal in a radio communication system according to the 11th embodiment;

FIG. 58 is a block diagram showing an example of a basic arrangement of principal part (OFDM transmitter unit and radio unit) of a transmission system of a base station;

FIG. 59 is a block diagram showing an example of a basic arrangement of principal part (radio unit and OFDM receiver unit) of a reception system of a terminal;

FIG. 60 is a block diagram showing an example of a basic arrangement of principal part (FH transmitter unit and radio unit) of a transmission system of the terminal; and

FIG. 61 is a block diagram showing an example of a basic arrangement of principal part (radio unit and FH receiver unit) of a reception system of the base station.

### DETAILED DESCRIPTION OF THE INVENTION

Preferred embodiments of the present invention will be described in detail hereinafter with reference to the accompanying drawings.

An overview of a communication system according to this embodiment will be described below.

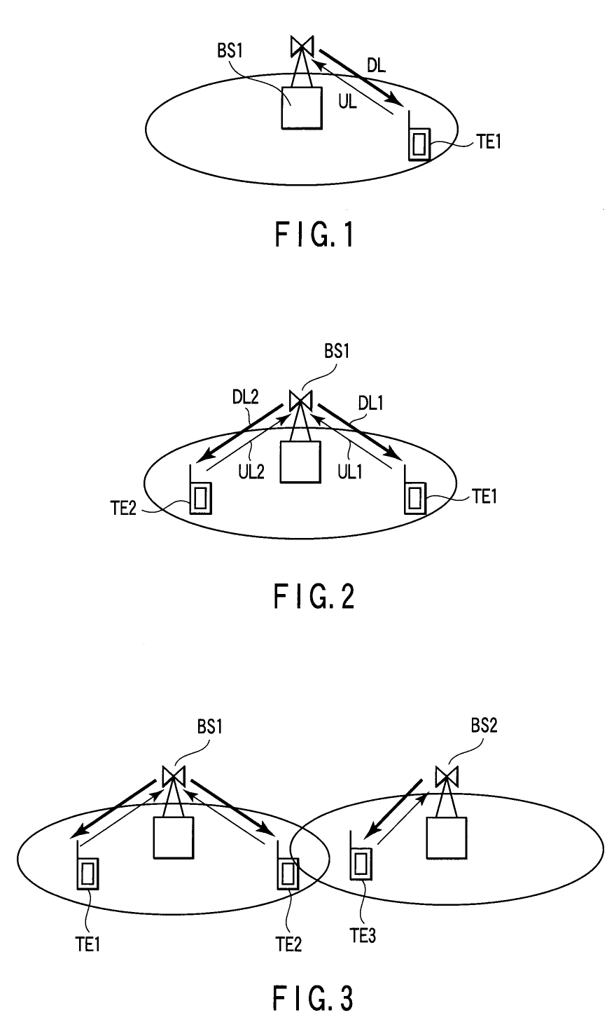

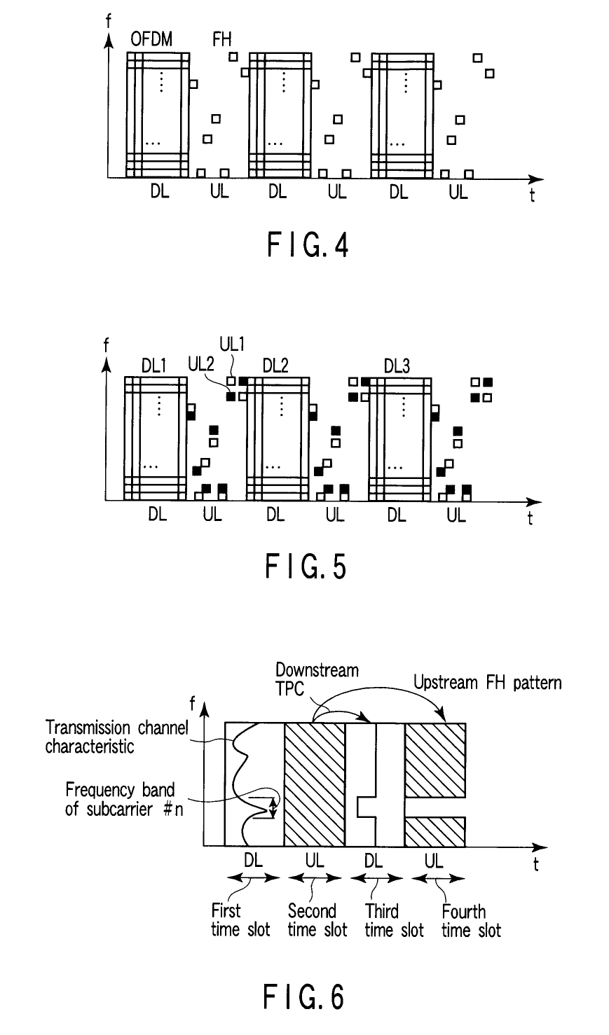

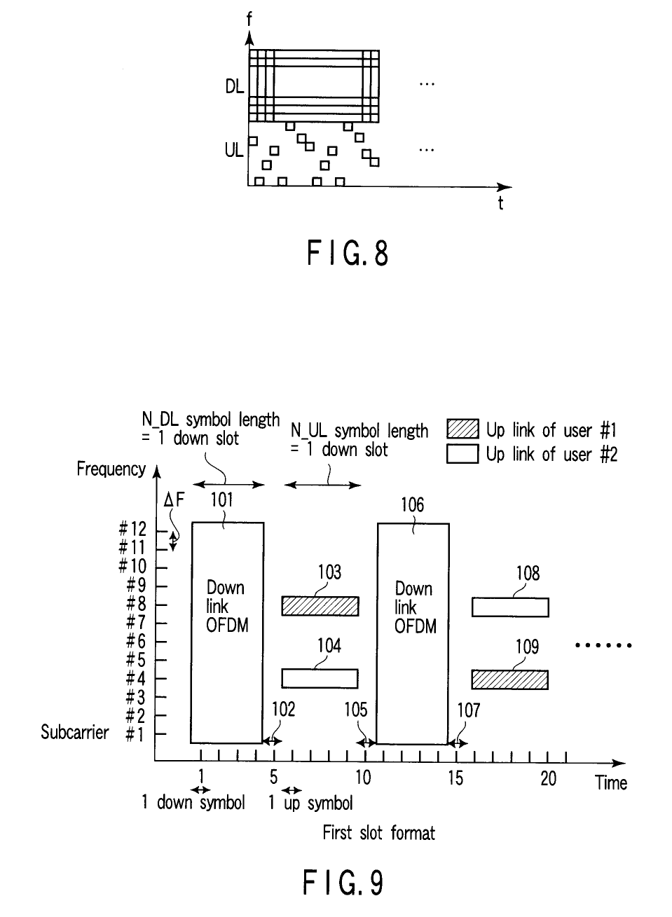

FIG. 1 illustrates an example of a schematic arrangement of a whole radio communication system. Referring to FIG. 1, a terminal TE1 and base station (or radio access point) BS1 make two-way communications. In order to allow easy downloading of images and files, the average data rate of an down link (DL) is faster than an up link (UL). To implement this, the system of this embodiment do communications using a modulation method based on OFDM (Orthogonal Frequency Division Multiplexing) using a multi-carrier signal including a plurality of subcarriers in the down link, and FH (Frequency Hopping) in the up link (see FIGS. 4 and 8).

With this arrangement, an up link with a narrow signal bandwidth and dynamic range can be realized while assuring a high-speed data rate, thus reducing power consumption of the terminal.

In order to realize two-way communications by a downstream OFDM communication and upstream FH communication, either TDD (Time Division Duplex) or FDD (Frequency Division Duplex) is used. The case of the former will be explained first.

FIG. 4 shows a case wherein TDD communications are done using an identical frequency band in the down and up links. Since an OFDM signal used in the down link is transmitted using a full radio band, the receiving side estimates (measures) the transmission channel distortions (e.g., amplitude and phase distortions) and power for each subcarrier, thus accurately estimating the radio transmission channel characteristics. On the other hand, since FH hops the carrier frequency (since the radio frequency used frequently varies), it is difficult to accurately measure the radio transmission channel characteristics of each subcarrier.

However, since OFDM and FH are combined using TDD, information indicating the state of the radio transmission channel recognized via each OFDM subcarrier (by estimating the transmission channel characteristics of that subcarrier) can be used in FH communication. For example, while the transmission channel characteristics of each OFDM subcarrier signal are measured in the down channel, transmission power control and antenna directivity control, preferential assignment of a high-quality frequency to an FH hopping pattern, and the like can be easily implemented in the up channel.

In this way, according to the radio communication system, data transmission at a high-speed data rate can be made, and the power consumption of the terminal can be reduced. Also, system control can be facilitated, and high communication quality can be realized.

Since the radio communication system applies a multiplexing scheme such as TDMA, CDMA, or the like to an OFDM signal in the down link, and a multiplexing scheme based on an FH hopping pattern in the up link, as shown in FIG. 2, a plurality of users can be accommodated. By adopting such schemes, even in a system in which communication areas overlap each other and are distributed in a cellular pattern, as shown in FIG. 3, interference control can be easily made. FIG. 5 shows a case wherein signals of a plurality of users are accommodated in the down link.

A case will be explained below with reference to FIG. 8 wherein two-way communications are realized using different frequencies in the OFDM down link and FH up link, i.e., FDD (Frequency Division Duplex). In this case, since the transmission timings of the base station and terminal can be independently designed, synchronization control in the radio communication system can be simplified. In the same manner as in two-way communications based on TDD, data transmission can be made at a high-speed data rate, and the power consumption of each terminal can be reduced. Also, system control can be facilitated, and high communication quality can be realized.

A radio communication system that performs TDD communications, i.e., a downstream OFDM communication and upstream FH communication, will be explained below.

### FIRST EMBODIMENT

The arrangements of a base station and terminal which can be applied to the radio communication system that performs two-way communications, i.e., a downstream OFDM communication and upstream FH communication, will be described first.

### (Arrangement of Base Station)

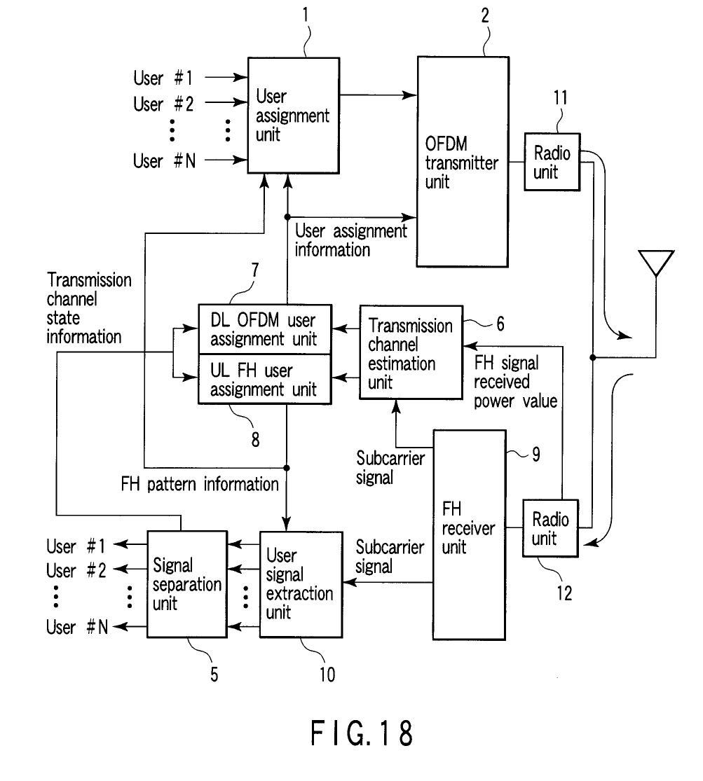

FIG. 18 shows an example of the arrangement of the base station.

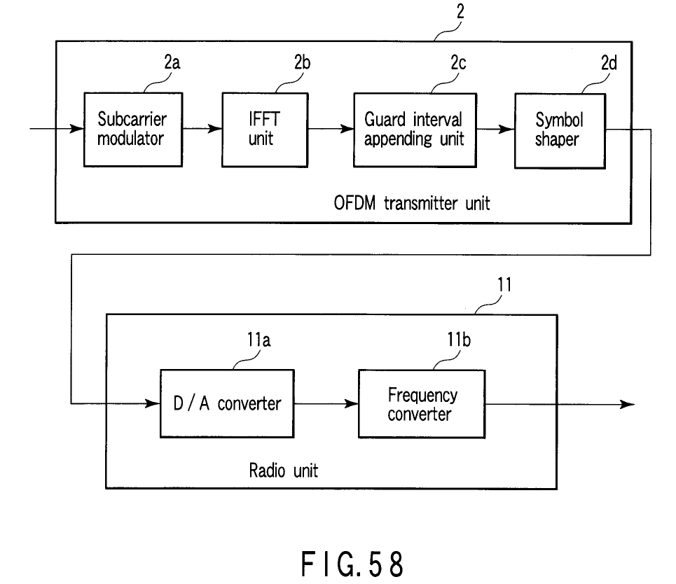

Data to be transmitted from the base station to respective users #1 to #N are sorted by a user assignment unit 1 using FH pattern information output from an UL FH user assignment unit 8 and user assignment information output from a DL OFDM user assignment unit 7. The sorted signals (divided into subcarriers) addressed to respective users are modulated by an OFDM transmitter unit 2, as shown in FIG. 58. That is, in the OFDM transmitter unit 2, a subcarrier modulator 2a modulates subcarrier signals, and an IFFT unit 2b generates a multi-carrier signal by IFFT (inverse Fourier transformation). A guard interval appending unit 2c appends a guard interval to the multi-carrier signal, and a symbol shaper 2d shapes its waveform. A baseband signal obtained in this way is passed to a radio unit 11. In the radio unit 11, a D/A converter 11a converts the digital baseband signal into an analog signal, and a frequency converter 11b converts the analog baseband signal into an intermediate frequency (IF) and then into a radio frequency (RF), thus transmitting the converted signal via an antenna.

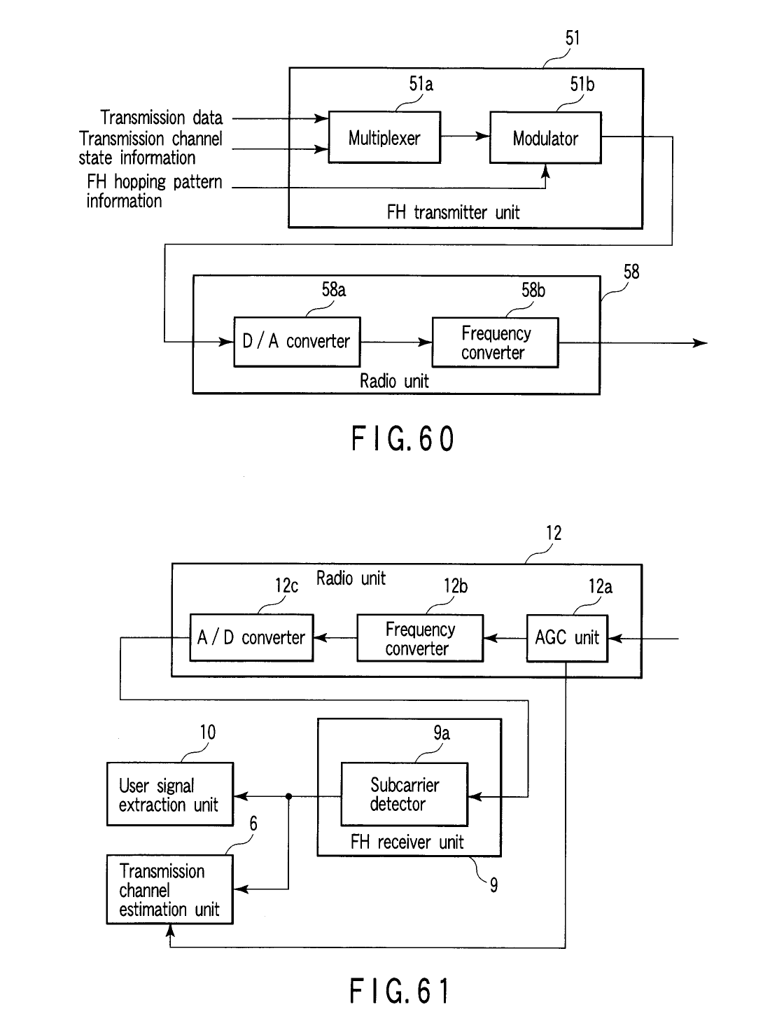

An FH signal transmitted from each terminal is received by a radio unit 12. As shown in FIG. 61, the radio unit 12 corrects the level of the received signal by AGC (Automatic Gain Control) by an AGC unit 12a, and then converts the frequency of the received signal by a frequency converter 12b. An A/D converter 12c converts the analog signal into a digital signal, and outputs that received signal to an FH receiver unit 9.

In the FH receiver unit 9, a subcarrier detector 9a detects subcarrier signals from the received signal output from the radio unit 12. The subcarrier signals are output to a transmission channel estimation unit 6 and user signal extraction unit 10.

The transmission channel estimation unit 6 estimates the transmission channel characteristics of the up link from each terminal to the base station on the basis of subcarrier signals and the received power value of an FH signal measured for AGC by the radio unit 12. That is, the unit 6 estimates the transmission channel characteristics such as the transmission channel distortions, power value, power ratio, and the like of each subcarrier signal for each terminal. The transmission channel characteristics of the up link from each terminal to the base station, which are estimated by the transmission channel estimation unit 6, are output to the DL OFDM user assignment unit 7 and UL FH user assignment unit 8, and are used as information upon assigning channels to respective terminals in the up and down links in the same manner as the transmission channel state information.

Note that the DL OFDM user assignment unit 7 and UL FH user assignment unit 8 suffice to use one of the transmission channel characteristics estimated by the transmission channel estimation unit 6 and the transmission channel state information transmitted from each terminal upon assigning channels to respective terminals in the up and down links.

The subcarrier signals output from the FH receiver unit 9 are also input to the user signal extraction unit 10. The user signal extraction unit 10 extracts signals of respective users from the subcarrier signals using FH pattern information of respective terminals used in the currently received FH signal, and outputs corresponding user signals to respective terminals.

A signal separation unit 5 demodulates each user signal output from the user signal extraction unit 10, and separates transmission channel state information and user data from that user signal. The unit 6 outputs the transmission channel state information to the DL OFDM user assignment unit 7 and UL FH user assignment unit 8.

The DL OFDM user assignment unit 7 assigns channels (subcarriers, symbols, and the like) in the next down slot to respective terminals on the basis of the transmission channel state information, and outputs user assignment information indicating the assignment result. The UL FH user assignment unit 8 determines the FH patterns of respective users in the next up slot on the basis of the transmission channel estimation result, and outputs FH pattern information of respective users indicating that determination result.

### (Arrangement of Terminal)

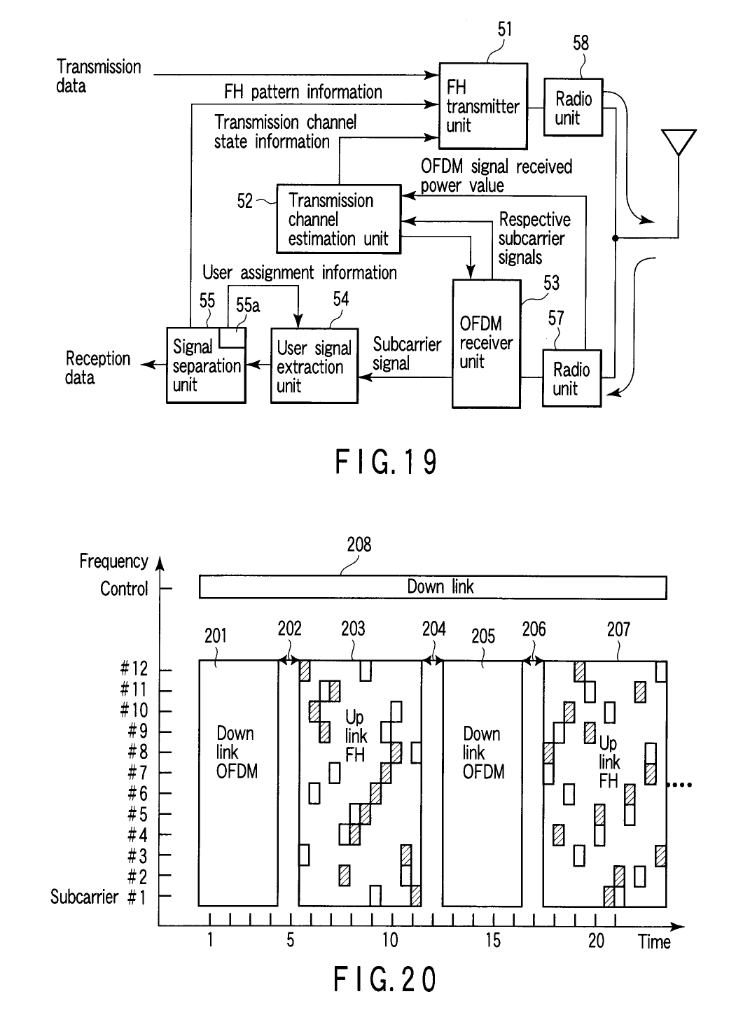

FIG. 19 shows an example of the arrangement of the terminal.

Data to be transmitted from each user to the base station is input to an FH transmitter unit 51. In the FH transmitter unit 51, as shown in FIG. 60, a multiplexer 51a multiplexes input transmission data to be transmitted to the base station and transmission channel state information output from a transmission channel estimation unit 52. Also, a modulator 51b modulates the multiplexed data using FH pattern information sent from the base station (obtained by a signal separation unit 55). In a radio unit 58, a D/A converter 58a converts a digital baseband signal obtained as a result of modulation into an analog signal, and a frequency converter 58b frequency converts that analog baseband signal, thus transmitting the converted signal via an antenna.

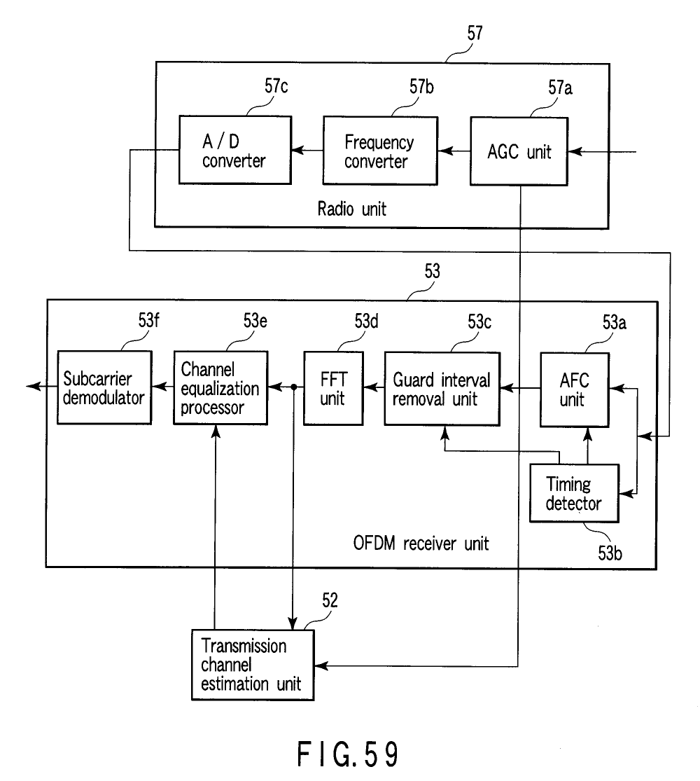

An OFDM signal transmitted from the base station is received by a radio unit 57. In the radio unit 58, as shown in FIG. 59, an AGC unit 57a corrects the level of the received signal, and a frequency converter 57b frequency-converts the received signal. Furthermore, an A/D converter 57c converts the received signal from an analog signal into a digital signal, and outputs the digital signal to an OFDM receiver unit 53.

The OFDM receiver unit 53 applies, to the received signal output from the radio unit 57, a carrier frequency synchronization process (for adjusting a carrier frequency error between the transmitter and receiver to attain synchronization) by an AFC unit 53a and a symbol timing synchronization process (for synchronizing the timings of OFDM symbols and a demodulation process) by a timing detector 53b using known signals for attaining synchronization (preamble signal, pilot signal) included in the received signal, and a guard interval removal unit 53c removes a guard interval. After that, an FFT unit 53d executes a branching process of a multi-carrier signal by FFT (Fourier transformation), and the obtained subcarrier signals are output to a channel equalization processor 53e and the transmission channel estimation unit 52. The channel equalization processor 53e executes a process (synchronous detection) for obtaining data signals from the subcarrier signals on the basis of the transmission channel distortions (phase and amplitude distortions of subcarrier signals) estimated from the subcarriers (e.g., estimated by a channel estimation circuit included in the transmission channel estimation unit 52). Note that it is a common practice to use a channel equalization circuit to perform synchronous detection using the estimated transmission channel distortions. A subcarrier demodulator 53f demodulates the subcarrier signals, and outputs them to a user signal extraction unit 54.

An AGC unit 57a of the radio unit 57 measures the received power of the received OFDM signal for the AGC. The measured received power value of the OFDM signal is output to the transmission channel estimation unit 52. The OFDM receiver unit 53 also outputs subcarrier signals (including pilot signals (known signals) included in them) obtained by FFT to the transmission channel estimation unit 52.

The transmission channel estimation unit 52 has a channel estimation circuit used to estimate the phase and amplitude distortions of subcarrier signals from the input subcarrier signals. This channel estimation circuit estimates the transmission channel distortions from the respective subcarrier signals. The estimated transmission channel distortions are also used in the aforementioned synchronous detection process. Furthermore, the transmission channel estimation unit 52 measures the power values of the input subcarrier signals. Moreover, the unit 52 calculates power ratios (S/N (signal to noise) ratios) of the respective subcarrier signals on the basis of the power values of the subcarrier signals and the received power value of the OFDM signal measured for AGC.

The transmission channel estimation unit 52 detects a subcarrier signal with a poor transmission channel state (e.g., a subcarrier signal whose transmission channel distortions, power value, and power ratio are lower than predetermined threshold values) on the basis of the transmission channel characteristics such as the transmission channel distortions, power values, power ratios, and the like estimated for respective subcarriers, and generates transmission channel state information including an identifier (e.g., a number) of that subcarrier signal. Also, the unit 52 generates transmission channel state information including the transmission channel distortions (phase and amplitude distortions), power values, and power ratios estimated for respective subcarriers. Furthermore, the unit 52 generates transmission channel state information including an identifier of a subcarrier signal with a poor transmission channel state, which is determined based on the transmission channel distortions (phase and amplitude distortions), power values, and power ratios estimated for respective subcarriers.

The transmission channel estimation unit 52 may determine a hopping pattern using subcarrier signals with a good transmission channel state (e.g., subcarrier signals whose transmission channel distortions, power values, and power ratios are equal to or higher than predetermined threshold values) on the basis of the estimated transmission channel characteristics. In this case, the transmission channel state information may include the determined hopping pattern.

The transmission channel state information is transmitted to the base station via the FH transmitter unit 51.

When the transmission channel state information is received by the base station, it is used upon determining hopping patterns for respective users in the UL FH user assignment unit 8, and is also used upon assigning subcarriers to respective users in the DL OFDM user assignment unit 7, as described above.

The user signal extraction unit 54 extracts a signal addressed to the self terminal from the subcarrier signals output from the OFDM receiver unit 53. In this case, the unit 54 refers to user assignment information which is received in advance and is stored in a storage unit 55a. The user signal extraction unit 54 demodulates the extracted signal addressed to the self terminal, and outputs it to the signal separation unit 55.

The signal separation unit 55 separates user assignment information, an FH pattern, and received data addressed to the self terminal, which are included in the user signal, from the user signal output from the user signal extraction unit 54. The user assignment information is temporarily stored in the storage unit 55a since it is used upon extracting a signal addressed to the self terminal from the next OFDM signal to be received (by the user signal extraction unit 54). The FH pattern information is output to the FH transmitter unit 51, and is used in frequency hopping in the next up slot.

### (Operations of Base Station and Terminal)

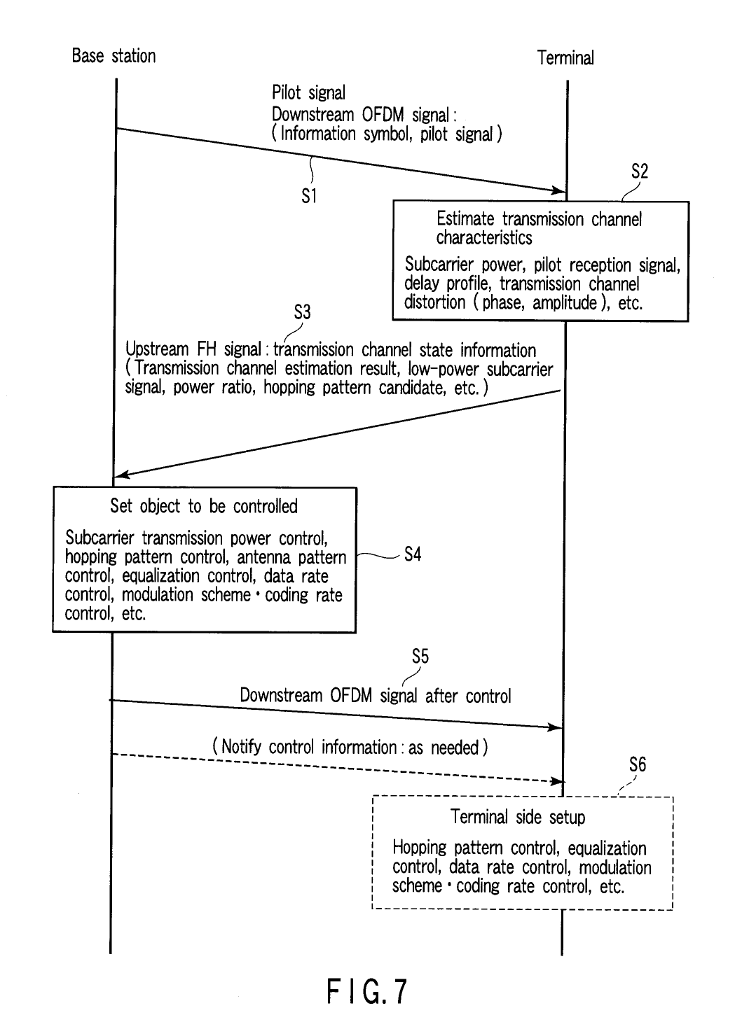

FIG. 6 is a view for explaining a case wherein transmission power control, FH hopping pattern control, and the like are executed using information that indicates the transmission channel characteristics estimated by each terminal which receives an OFDM signal transmitted in the down link. FIG. 7 is a flowchart for explaining the operations at that time. The operations will be explained below with reference to FIGS. 6 and 7.

In the radio communication system, the terminal side estimates (measures) the transmission channel characteristics (e.g., the subcarrier power value, transmission channel distortions (phase and amplitude), delay profile, transmission channel frequency response, and the like) from an OFDM signal (e.g., the information symbol, pilot signal, and the like) of the down link, which is transmitted in a first time slot, by utilizing the OFDM down link (steps S1 and S2 in FIG. 7). Information obtained as a result of estimation (e.g., transmission channel state information including at least one of the subcarrier number indicating a low-power subcarrier, the received power values and S/N ratios (signal to noise ratios) of subcarriers, hopping pattern candidate, and the like) is transmitted to the base station side using the up link of the next second time slot (step S3 in FIG. 7). The base station performs transmission power control (TPC) in the down link of third time slot, and determines an FH hopping pattern in the up link of fourth time slot on the basis of the transmission channel state information (step S4 in FIG. 7).

For example, in FIG. 6, since the transmission channel characteristics (e.g., the received power value) of the frequency band of subcarrier #n are lower than a predetermined threshold value, an OFDM signal that increases the transmission power of subcarrier #n is transmitted in the third time slot (step S5 in FIG. 7). Alternatively, a pattern is determined not to hop the frequency band of subcarrier #n in the fourth time slot, and the terminal side is notified of the determined hopping pattern. The terminal side makes transmission using the notified hopping pattern (step S6 in FIG. 7).

By using such method, a radio communication system which can maintain high communication quality independently of the radio transmission state can be realized.

Note that the objects to be controlled are not limited to the transmission power control and FH hopping pattern control shown in FIG. 6, and the base station can do control such as antenna directivity control, adaptive modulation, and the like on the basis of various kinds of information included in the transmission channel state information transmitted from each terminal.

Next, the allocation of channels of respective terminals assigned to respective up and down time slots by the DL OFDM user assignment unit 7 and UL FH user assignment unit 8 in the base station will be explained below.

### (First Slot Format)

FIG. 9 shows an example of the first slot format. A downstream communication from the base station to each terminal and an upstream communication from each terminal to the base station are temporally multiplexed and are made using an identical frequency band. Also, a minimum unit of the frequency to be hopped in an FH communication of the up link is the same as a frequency interval ΔF of subcarriers in an OFDM communication of the down link.

The base station transmits an OFDM signal of N_DL symbols (N_DL is an integer equal to or larger than 1) using a frequency-time region 101. That is, N_DL symbols are transmitted via one down slot. Note that one symbol corresponds to a signal waveform that can be transmitted per unit time. In FIG. 9, data for four symbols are transmitted in one down slot using subcarriers #1 to #12.

After an interval time 102 elapses upon completion of transmission of the OFDM signal by the base station, each terminal successively transmits N_UL symbols (N_UL is an integer equal to or larger than 1) in one up slot using a frequency band designated in advance by the base station. That is, one up slot corresponds to a duration for an N_UL symbol length.

In FIG. 9, a terminal of user #1 successively transmits eight symbols in one up slot using subcarrier #8. Also, a terminal of user #2 successively transmits eight symbols in one up slot using subcarrier #4.

After an interval time 105 elapses upon completion of transmission of respective terminals, the base station transmits a downstream OFDM signal again using a frequency-time region 106 to respective terminals. After an interval time 107, respective terminals do transmission using frequency bands designated by the base station. Note that the designated frequency band need not always be the same as that used in the previous up slot. In FIG. 9, the terminal of user #1 do transmission using subcarrier #4, and user #2 do transmission using subcarrier #8. In this manner, the upstream communication is made by hopping the frequency for each up slot. In other words, the hopping period is an N_UL symbol length time.

According to the first slot format, the frequency band (subcarrier) with good characteristics is preferentially selected to determine an upstream hopping pattern using the transmission channel characteristics of respective subcarriers estimated (measured) on the terminal side, thus improving the transmission efficiency of an upstream communication.

### (Second Slot Format)

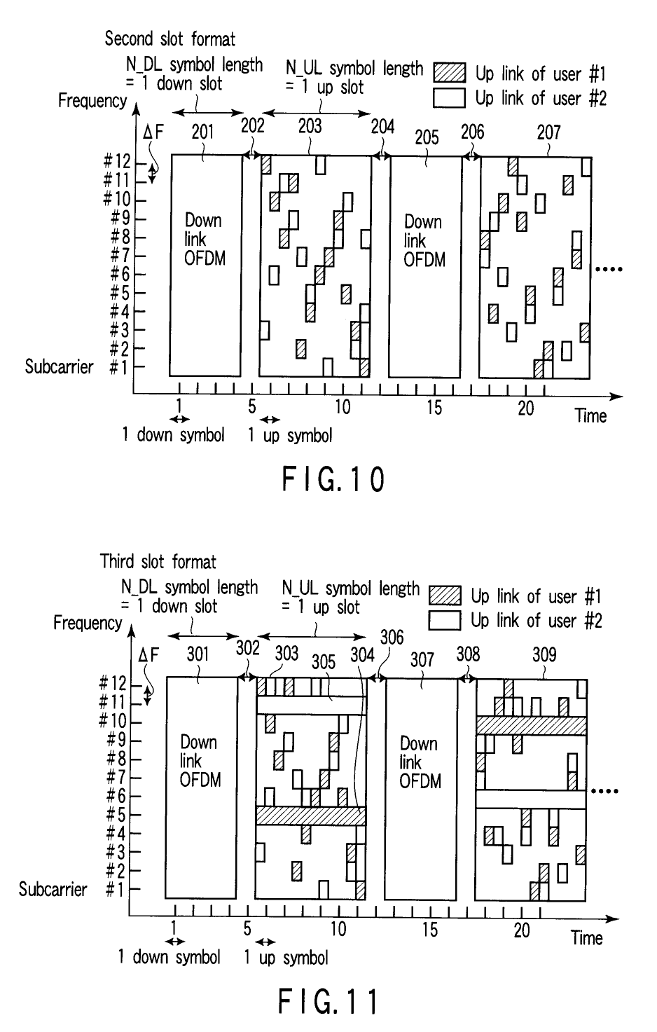

FIG. 10 shows an example of the second slot format. A downstream communication from the base station to each terminal and an upstream communication from each terminal to the base station are temporally multiplexed and are done using an identical frequency band. Also, a minimum unit of the frequency to be hopped in an FH communication of the up link is the same as a frequency interval ΔF of subcarriers in an OFDM communication of the down link.

The base station transmits an OFDM signal of N_DL symbols (N_DL is an integer equal to or larger than 1) using a frequency-time region 201. That is, N_DL symbols are transmitted via one down slot. In FIG. 10, data for four symbols (one down slot) are transmitted using subcarriers #1 to #12.

After an interval time 202 elapses upon completion of transmission of the OFDM signal by the base station, each terminal transmits N_UL symbols (N_UL is an integer equal to or larger than 1) in one up slot using the hopping pattern of a hopping period (1/M (M is an integer equal to or larger than 1) symbol length time) designated in advance by the base station from a frequency-time region 203.

In FIG. 10, user #1 transmits data for one symbol using subcarriers #12 and #10 at time “6”. Likewise, user #1 transmits data for a total of six symbols in one up slot using subcarriers #8, #11, #2, #4, #6, #7, #9, #5, #3, and #1 in turn from time “7” to time “11”. User #2 transmits data for six symbols in one up slot using subcarriers #3, #6, #11, #9, #7, #5, #12, #1, #8, #10, #2, and #4 in turn from time “6” to time “11”. With this slot format, N_UL=“6” and M=“2”.

After an interval time 204 elapses upon completion of transmission of respective terminals, the base station transmits a downstream OFDM signal again using a frequency-time region 205 to respective terminals. After an interval time 206, respective terminals do transmission using hopping patterns designated by the base station. Note that the designated hopping pattern need not always be the same as that used in the previous up slot.

According to the second slot format, the base station can precisely execute control such as adaptive modulation for respective subcarriers in a downstream OFDM signal on the basis of the high-precision transmission channel characteristics of the broad frequency band, which are notified by the terminals, thus improving the transmission efficiency of a downstream communication.

### (Third Slot Format)

FIG. 11 shows an example of the third slot format. A downstream communication from the base station to each terminal and an upstream communication from each terminal to the base station are temporally multiplexed and are done using an identical frequency band. Also, the minimum unit of the frequency to be hopped in an FH communication of the up link is the same as a frequency interval ΔF of subcarriers in an OFDM communication of the down link.

The base station transmits an OFDM signal of N_DL symbols (N_DL is an integer equal to or larger than 1) using a frequency-time region 301. In FIG. 11, data for four symbols are transmitted in one down slot using subcarriers #1 to #12.

After an interval time 302 elapses upon completion of transmission of the OFDM signal by the base station, each terminal transmits data for N_UL symbols (N_UL is an integer equal to or larger than 1) in one up slot using a frequency designated in advance by the base station from a frequency-time region 303. At the same time, each terminal transmits data for N_UL symbols using the hopping pattern of a 1/M symbol length period designated by the base station. Therefore, each terminal transmits signals for a total of 2×N_UL symbols.

In FIG. 11, user #1 transmits data for six symbols using subcarrier #5 (frequency-time region 304), and transmits data for four symbols using subcarriers #12, #10, #8, #12, #2, #4, #6, #7, #9, #6, #3, and #1 in turn from time “6” to time “11 at the same time. Hence, user #1 transmits data for a total of 12 symbols in one up slot. Likewise, user #2 transmits data for six symbols using subcarrier #11 (frequency-time region 305), and transmits data for four symbols using subcarriers #3, #6, #12, #9, #7, #6, #12, #1, #8, #10, 2, and #4 in turn from time “6” to time “11”. Hence, user #2 transmits data for a total of 12 symbols in one up slot.

After an interval time 306 elapses upon completion of transmission of respective terminals, the base station transmits a downstream OFDM signal again using a frequency-time region 307 to respective terminals. After an interval time 308, respective terminals do transmission using frequencies and hopping patterns designated by the base station. Note that the designated frequency and hopping pattern need not always be the same as those used in the previous up slot.

According to the third slot format, each terminal transmits signals using a first hopping pattern whose hopping period is a D_UL symbol length, and a second hopping pattern whose hopping period is a 1/M (M is an arbitrary positive integer) symbol length in one slot.

The frequency band (subcarrier) with good characteristics is preferentially selected to determine an upstream transmission frequency using the transmission channel characteristics of respective subcarriers estimated (measured) on the terminal side, thus improving the transmission efficiency of an upstream communication. The base station can precisely execute control such as adaptive modulation for respective subcarriers in a downstream OFDM signal on the basis of the high-precision transmission channel characteristics of the broad frequency band, which are notified by the terminals, thus improving the transmission efficiency of a downstream communication.

### (Fourth Slot Format)

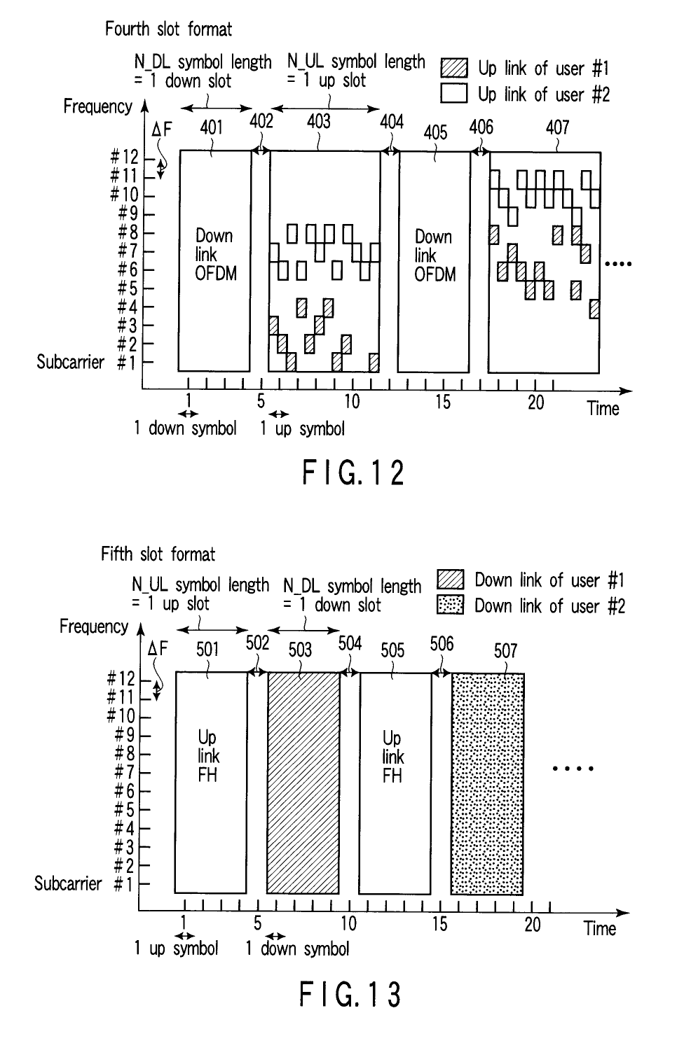

FIG. 12 shows an example of the fourth slot format. A downstream communication from the base station to each terminal and an upstream communication from each terminal to the base station are temporally multiplexed and are done using an identical frequency band. Also, the minimum unit of the frequency to be hopped in an FH communication of the up link is the same as a frequency interval ΔF of subcarriers in an OFDM communication of the down link.

The base station transmits an OFDM signal of N_DL symbols (N_DL is an integer equal to or larger than 1) using a frequency-time region 401. In FIG. 12, data for four symbols are transmitted in one down slot using subcarriers #1 to #12.

After an interval time 402 elapses upon completion of transmission of the OFDM signal by the base station, each terminal transmits data for N_UL symbols (N_UL is an integer equal to or larger than 1) in one up slot in a frequency-time region 403 using a hopping pattern having a hopping period of a 1/M (M is an integer equal to or larger than 1) symbol length designated in advance by the base station. Note that the frequency range used in this hopping pattern is limited to some of the frequency bands of subcarriers #1 to #8.

In FIG. 12, user #1 hops the frequency using the frequency range of subcarriers #1, #2, #3, and #4. User #1 transmits data for one symbol using subcarriers #3 and #2 at time “6”. Likewise, user #1 transmits data for a total of six symbols in one up slot using subcarriers #1, #4, #2, #3, #4, #1, #2, #4, #3, and #1 in turn from time “8” to time “11”. User #2 hops the frequency using the frequency range of subcarriers #6, #7, and #8. User #2 transmits data for six symbols in one up slot using subcarriers #7, #6, #8, #6, #8, #7, #8, #6, #8, #7, #6, and #8 in turn from time “6” to time “11”. In this case, N_UL=“6” and M=“2”.

After an interval time 404 elapses upon completion of transmission of respective terminals, the base station transmits a downstream OFDM signal again using a frequency-time region 405 to respective terminals. After an interval time 406, respective terminals do transmission using hopping patterns within frequency ranges designated by the base station. Note that the designated hopping pattern need not always be the same as that used in the previous up slot.

According to the fourth slot format, the frequency band (subcarrier) with good characteristics is preferentially selected to determine an upstream hopping pattern using the transmission channel characteristics of respective subcarriers estimated (measured) on the terminal side, thus improving the transmission efficiency of an upstream communication.

### (Fifth Slot Format)

FIG. 13 shows an example of the fifth slot format. A downstream communication from the base station to each terminal and an upstream communication from each terminal to the base station are temporally multiplexed and are done using an identical frequency band.

Each terminal transmits an FH signal of N_UL symbols (N_UL is an integer equal to or larger than 1) in one up slot using a frequency-time region 501.

After an interval time 502 elapses upon completion of transmission of the FH signal by the terminal, the base station transmits, to one user terminal, an OFDM signal of N_DL symbols (N_DL is an integer equal to or larger than 1) in one down slot using a frequency-time region 503. In FIG. 13, the base station transmits data for four symbols in one down slot to user #1 from time “6” to time “19”.

After an interval time 504 elapses upon completion of transmission to one user by the base station, each terminal transmits an upstream FH signal again using a frequency-time region 505. After an interval time 506, the base station transmits, to one user, an OFDM signal for N_DL symbols using a frequency-time region 507. In FIG. 13, the base station transmits data for four symbols in one down slot to user #2 from time “16” to time “19”.

With such slot format, since each terminal need not execute any reception process if it does not have any data to be received, the power consumption of the terminal can be reduced. Since a user terminal to be received is switched for each down slot, transmission power control and the like for each user terminal can be made with a sufficient time margin.

### (Sixth Slot Format)

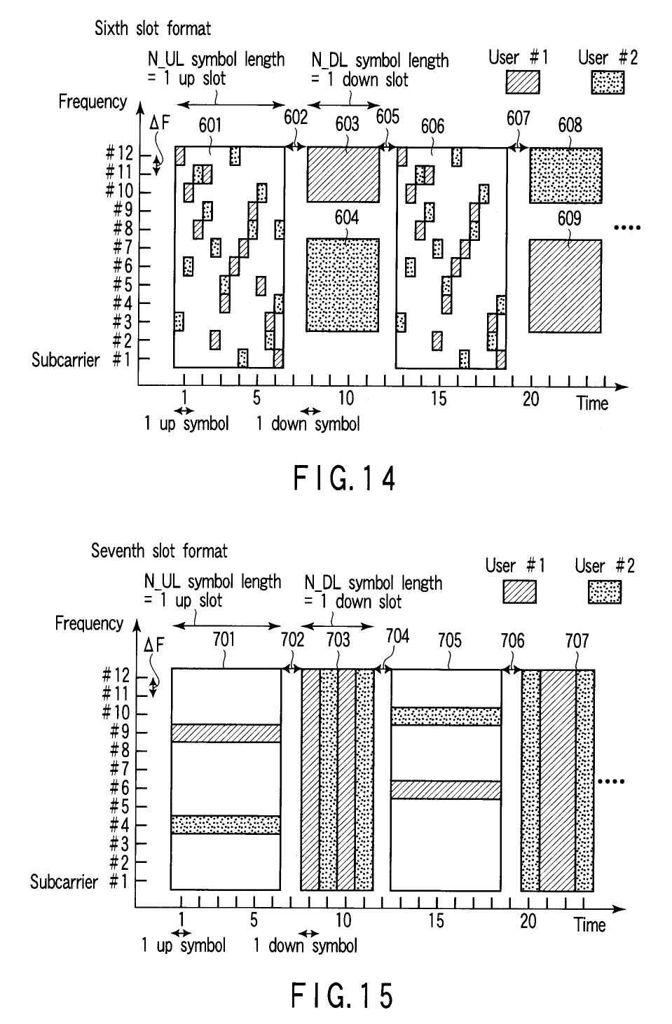

FIG. 14 shows an example of the sixth slot format. A downstream communication from the base station to each terminal and an upstream communication from each terminal to the base station are temporally multiplexed and are done using an identical frequency band. Also, the minimum unit of the frequency to be hopped in an FH communication of the up link is the same as a frequency interval ΔF of subcarriers in an OFDM communication of the down link.

Each user terminal transmits an FH signal for N_UL symbols (N_UL is an integer equal to or larger than 1) in one up slot using a frequency-time region 601. Note that the hopping pattern of the upstream FH signal uses all subcarrier signals at least once.

After an interval time 602 elapses upon completion of the FH signals by the respective users, the base station assigns data of respective users to respective subcarriers, and transmits an OFDM signal for N_DL symbols (N_DL is an integer equal to or larger than 1) in one down slot.

In FIG. 14, the base station transmits data for four symbols in one down slot using subcarriers #10, #11, and #12 to user #1 from time “8” to time “11”. Also, the base station transmits data for four symbols to user #2 in one down slot using subcarriers #3, #4, #5, and #6.

After an interval time 605 elapses upon completion of transmission to respective users by the base station, each terminal transmits an FH signal to the base station again using a frequency-time region 606. After a time interval 607, the base station transmits an OFDM signal for N_DL symbols to each user. At this time, subcarriers to be assigned to each user need always be the same as those assigned in the previous down slot. That is, the base station changes subcarriers to be assigned to each terminal every time it transmits an OFDM signal for N_DL symbols to each terminal.

According to the sixth slot format, the base station preferentially selects the frequency bands (subcarriers) with good characteristics for each terminal using the transmission channel characteristics for respective subcarriers, which are estimated (measured) on the terminal side, and can assign subcarriers in each down slot to that terminal. Therefore, the transmission efficiency of a downstream communication can be improved.

### (Seventh Slot Format)

FIG. 15 shows an example of the seventh slot format. A downstream communication from the base station to each terminal and an upstream communication from each terminal to the base station are temporally multiplexed and are done using an identical frequency band. Also, the minimum unit of the frequency to be hopped in an FH communication of the up link is the same as a frequency interval ΔF of subcarriers in an OFDM communication of the down link.

Each user transmits an FH signal for N_UL symbols (N_UL is an integer equal to or larger than 1) in one up slot using a frequency-time region 701. Note that the frequency band to be assigned changes for each up slot in the hopping pattern of the FH signal. In this example, users #1 and #2 transmit data for six symbols in one up slots using subcarriers #9 and #4, respectively.

After an interval time 702 elapses upon completion of transmission of FH signals by respective users, the base station transmits an OFDM signal for N_DL symbols (N_DL is an integer equal to or larger than 1) in one down slot by assigning data of respective users to respective symbols. Note that the base station transmits data for two symbols to each user terminal by assigning user #1 to times “8” and “10” and user #2 to times “9” and “11”.

In this manner, the base station assigns the contents of a down slot used to transmit an OFDM signal to each terminal for one symbol length. That is, signals addressed to respective terminals are multiplexed by TDMA (Time Division Multiple Access) in the down slot.

After an interval time 702 elapses upon completion of transmission to respective users by the base station, each terminal transmits an upstream FH signal to the base station again using a frequency-time region 705. After an interval 706, the base station transmits an OFDM signal for N_DL symbols to each user. Note that a symbol to be assigned to each user need not always be the same as that to be assigned in the previous down slot.

According to the seventh slot format, since the terminal side receives data of all the frequency bands (subcarriers #1 to #12 in this case), it can precisely estimate the transmission channel characteristics of respective subcarriers. The base station preferentially selects the frequency bands with good characteristics for each terminal using the transmission channel characteristics estimated by each terminal, and determines a hopping pattern of that terminal, thus improving the transmission efficiency of an upstream communication.

### (Eighth Slot Format)

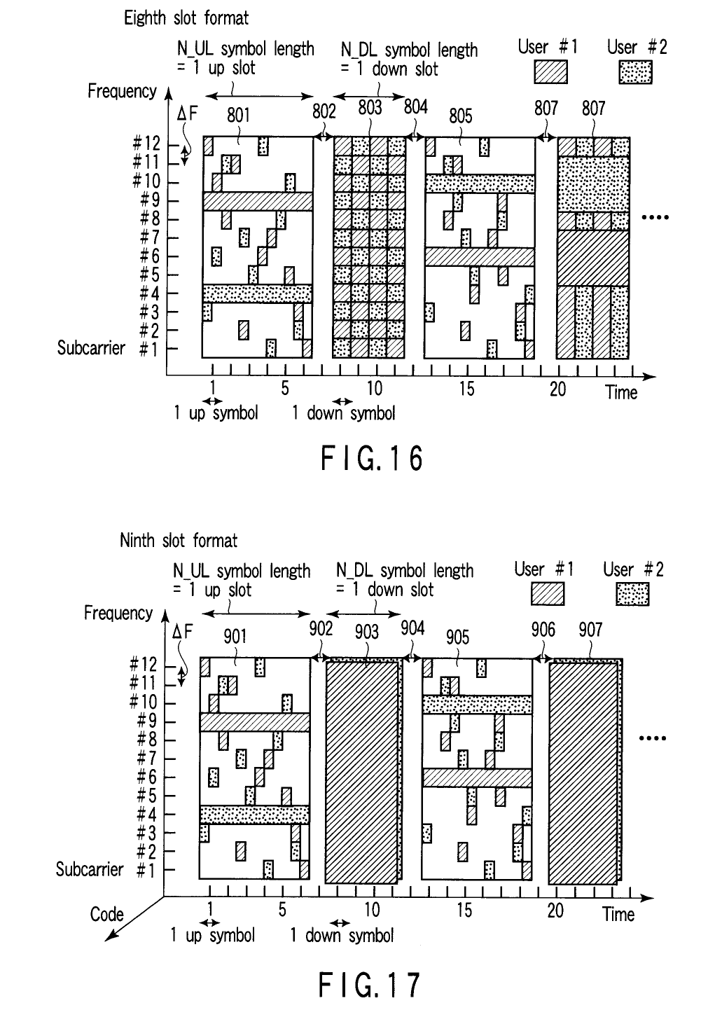

FIG. 16 shows an example of the eighth slot format. A downstream communication from the base station to each terminal and an upstream communication from each terminal to the base station are temporally multiplexed and are done using an identical frequency band. Also, the minimum unit of the frequency to be hopped in an FH communication of the up link is the same as a frequency interval ΔF of subcarriers in an OFDM communication of the down link.

Each user transmits an FH signal for N_UL symbols (N_UL is an integer equal to or larger than 1) in one up slot using a frequency-time region 801. In one up slot, each terminal transmits a signal using a first hopping pattern whose hopping period is a D_UL symbol length, and a second hopping pattern whose hopping period is an 1/M (M is an arbitrary positive integer) symbol length. That is, the first hopping pattern is a hopping pattern in which the frequency bands to be assigned change for each up slot, and the second hopping pattern is a hopping pattern using all subcarriers in one up slot.

In FIG. 16, terminals of users #1 and #2 transmit data for six symbols in one up slot using subcarriers #9 and #4, respectively. Furthermore, each terminal transmits data for six symbols using the hopping pattern using all subcarriers. Therefore, each terminal transmits data for a total of 12 symbols in one up slot.

After an interval time 802 elapses upon completion of transmission of FH signals by respective users, the base station transmits an OFDM signal for N_DL symbols (N_DL is an integer equal to or larger than 1) by assigning data of respective users for each symbol length and each carrier using a frequency-time region 803. Since signals for users #1 and #2 are alternately allocated in frequency-time region 803 in FIG. 16, each user receives data of all the subcarriers.

After an interval time 804 elapses upon completion of transmission to respective users by the base station, each terminal transmits an upstream FH signal to the base station again using a frequency-time region 805. After an interval time 806, the base station transmits an OFDM signal for N_DL symbols to each user. At this time, carriers and symbols to be assigned to each user need not always be the same as those assigned in the previous up slot. That is, the base station changes symbols and subcarriers to be assigned to each user in the down slot every time it transmits an OFDM signal for N_DL symbols.

In an up slot 805 and down slot 807 in FIG. 16, it is determined that the transmission channel state in the frequency band of subcarrier #6 is good between user #1 and the base station. User #1 and the base station efficiently make data communications mainly using the frequency band of subcarrier #6. At the same time, since data communications are done using other subcarriers, the transmission channel states of these subcarriers can always be monitored.

According to the eighth slot format, when the transmission channel state is to be measured or when an improvement request of the transmission efficiency or the like is issued in the base station and terminal, the frequency bands can be assigned to meet such requests.

### (Ninth Slot Format)

FIG. 17 shows an example of the ninth slot format. A downstream communication from the base station to each terminal and an upstream communication from each terminal to the base station are temporally multiplexed and are done using an identical frequency band. Also, the minimum unit of the frequency to be hopped in an FH communication of the up link is the same as a frequency interval ΔF of subcarriers in an OFDM communication of the down link.

Each user transmits an FH signal for N_UL symbols (N_UL is an integer equal to or larger than 1) in one up slot using a frequency-time region 901. In one up slot, each terminal transmits a signal using a first hopping pattern whose hopping period is a D_UL symbol length, and a second hopping pattern whose hopping period is an 1/M (M is an arbitrary positive integer) symbol length. That is, the first hopping pattern is a hopping pattern in which the frequency bands to be assigned change for each up slot, and the second hopping pattern is a hopping pattern using all subcarriers in one up slot.

In FIG. 17, terminals of users #1 and #2 transmit data for six symbols in one up slot using subcarriers #9 and #4, respectively. Furthermore, each terminal transmits data for six symbols using the hopping pattern using all subcarriers. Therefore, each of terminals of users #1 and #2 transmits data for a total of 12 symbols in one up slot.

After an interval time 902 elapses upon completion of transmission of FH signals by respective users, the base station transmits an OFDM-CDMA (Code Division Multiple Access) signal generated by multiplexing data of respective users using orthogonal codes using a frequency-time region 903. In FIG. 17, the base station transmits an OFDM-CDMA signal for N_DL symbols (N_DL is an integer equal to or larger than 1) in one down slot by multiplexing signals for users #1 and #2 using spread codes assigned to these users.

After an interval time 904 elapses upon completion of transmission to respective users by the base station, each terminal transmits an upstream FH signal to the base station again using a frequency-time region 905. After an interval time 906, the base station transmits an OFDM-CDMA signal for N_DL symbols to each user. At this time, the spread code to be assigned to each user need not always be the same as that assigned in the previous up slot. Since each user terminal receives data from all the subcarriers, it can precisely measure the transmission channel characteristics of respective subcarriers.

In an up slot 905 in FIG. 17, it is determined that the transmission channel state in the frequency band of subcarrier #6 is good between user #1 and the base station. User #1 and the base station efficiently make data communications mainly using the frequency band of subcarrier #6. At the same time, since data communications are made using other subcarriers, the transmission channel states of these subcarriers can always be monitored.

With the ninth slot format, since the terminal side receives data of all the frequency bands, it can precisely estimate the transmission channel characteristics of respective subcarriers. The base station preferentially selects the frequency bands with good characteristics for each terminal using the transmission channel characteristics estimated by each terminal, and determines a hopping pattern of that terminal, thus improving the transmission efficiency of an upstream communication.

As described above, according to the first embodiment, the following effects are obtained.

(1) High-speed data transmission is allowed since OFDM is used in the up link, and channel interference can be suppressed since FH is used in the up link. Furthermore, a terminal transmission power amplifier with high efficiency can be used, and the communication time of each terminal can be prolonged. (2) Since transmission is done using an identical frequency in the up and down links and also using the all frequency bands in the down link, the terminal side can adequately measure the transmission channel state between that terminal and the base station. This measurement result can be used in transmission power control, directivity control, equalization control, and the like in the up and down links, and it is particularly effective for FH whose carrier frequency changes periodically. (3) Since a hopping pattern of the up link is determined and a subcarrier to be used in a downstream communication of a plurality of subcarriers is determined on the basis of the transmission channel characteristics measured by the terminal that receives an OFDM signal in the down link, communications can be done using only the frequency band with a good transmission channel state for each terminal, thus realizing high-quality radio communications. (4) Since signals addressed to respective terminals are multiplexed by TDM (Time Division Multiplex) in a time slot of a downstream communication, transmission is done using all the frequency bands in the time slot of the downstream communication. Hence, the transmission channel state of each user can be adequately measured. This measurement result can be used in transmission power control, directivity control, equalization control, and the like in the up and down links for each user.

Variations of the radio communication system according to the first embodiment which performs TDD communications, i.e., a downstream OFDM communication and upstream FH communication, will be described hereinafter.

### SECOND EMBODIMENT

A schematic arrangement of a whole radio communication system according to the second embodiment will be described below with reference to FIG. 2. A base station BS1 transmits downstream OFDM signals DL1 and DL2 to terminals TE1 and TE2 for a predetermined period of time. Upon completion of transmission of the downstream OFDM signals by the base station, the terminals TE1 and TE2 transmit upstream FH signals UL1 and UL2 using the same frequency bands as the downstream OFDM signals to the base station BS1. In this way, the downstream OFDM signals and upstream FH signals are temporally multiplexed.

The base station BS1 transmits a time synchronization signal, paging signal (a signal that notifies each terminal of incoming call), and the like using the frequency bands other than those which are used by the downstream OFDM signals and upstream FH signals.

FIG. 20 shows a slot format example. The base station BS1 transmits data using OFDM to respective terminals using a frequency-time region 201 (subcarriers #1 to #12 and times “1” to “4”). After a guard time 202 elapses upon completion of transmission of the downstream OFDM signal by the base station BS1, each terminal transmits an FH signal using a hopping pattern which is determined in advance with the base station within the range of a frequency-time region 203 (subcarriers #1 to #12 and times “6” to “11”). Note that a hopping pattern that is distributed across all the frequencies (subcarriers #1 to #12) is preferably used in one up slot.

After a guard time 204 elapses upon completion of transmission of the upstream FH signal by each terminal, the base station transmits an OFDM signal again using a frequency-time region 205. In this way, the downstream OFDM signals and upstream FH signals use identical frequency bands by time multiplexing.

Also, the base station transmits a signal (control signal) including at least one of a time synchronization signal and paging signal using a frequency band (control signal dedicated frequency band) 208 which is different from those used by the downstream OFDM signals and upstream FH signals.

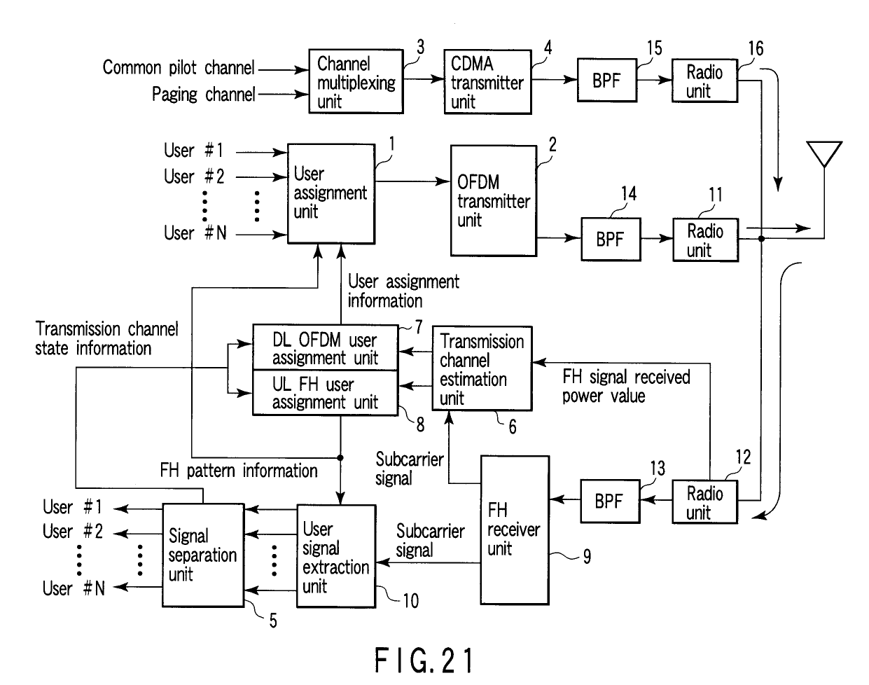

FIG. 21 shows an example of the arrangement of the base station BS1. Note that the same reference numerals in FIG. 21 denote the same parts as those in FIG. 18, and only characteristic features of this embodiment will be explained below. Data to be transmitted to respective users are multiplexed and sorted by a user assignment unit 1 using user assignment information, and are output to an OFDM transmitter unit 2. The signals addressed to the respective users are converted into an OFDM signal by the OFDM transmitter unit 2, and the OFDM signal is output to a radio unit 11 after it is band-limited by a band-pass filter (BPS) 14.

Upon completion of transmission of a downstream OFDM signal, an FH signal from each terminal is received by a radio unit 12. A signal output from the radio unit 12 is converted into a band-limited signal via a band-pass filter (BPF) 13, and the band-limited signal is input to an FH receiver unit 9.

The FH receiver unit 9 detects subcarrier signals from the received signal output from the radio unit 12. The subcarrier signals are output to a transmission channel estimation unit 6 and user signal extraction unit 10.

The transmission channel estimation unit 6 measures the transmission channel characteristics such as the transmission channel distortions, power values, power ratios, and the like for respective subcarrier signals for each terminal on the basis of the subcarrier signals and the received power value of the FH signal measured by the radio unit 12 for AGC. The transmission channel characteristics of an up link from each terminal to the base station estimated by the transmission channel estimation unit 6 are output to a DL OFDM user assignment unit 7 and UL FH user assignment unit 8, and are used in order to assign channels to respective terminals in the down and up links.

The base station BS1 transmits a common pilot signal (a known signal between the base station and each terminal: a time synchronization signal) for a synchronization process between the base station and each terminal, and a paging signal (common pilot channel, paging channel) using the control signal dedicated frequency band 208. The control signals are multiplexed by a channel multiplexing unit 3. In FIG. 21, the multiplexed control signal is input to a CDMA transmitter unit 4, and undergoes spread and modulation processes of CDMA (Code Division Multiple Access). The modulated control signal is band-limited via a band-pass filter (BPF) 15, and is then input to a radio unit 16. The radio unit 16 converts a digital signal output from the BPF 15 into an analog signal, and frequency-converts that analog signal, thus transmitting the converted signal using the frequency band 208 which is different from those for downstream OFDM signals and upstream FH signals.

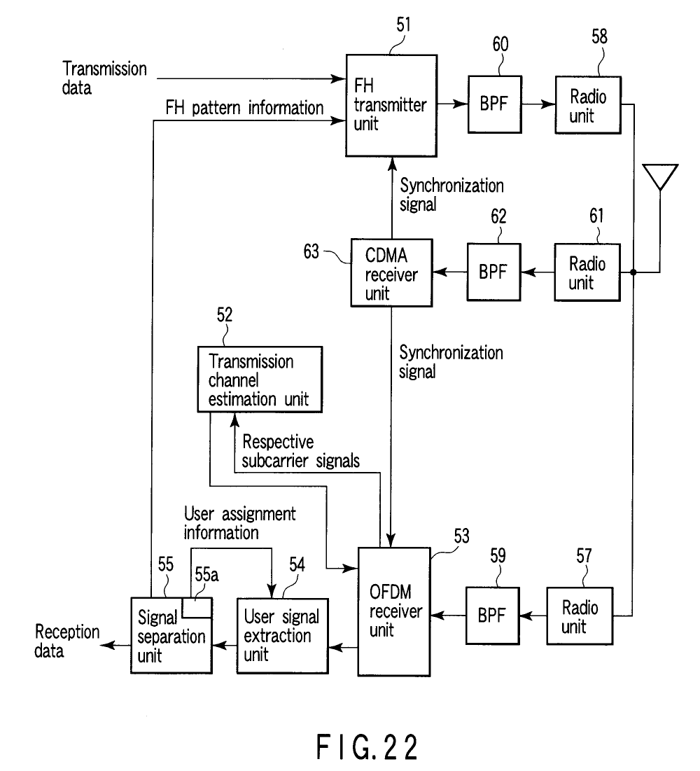

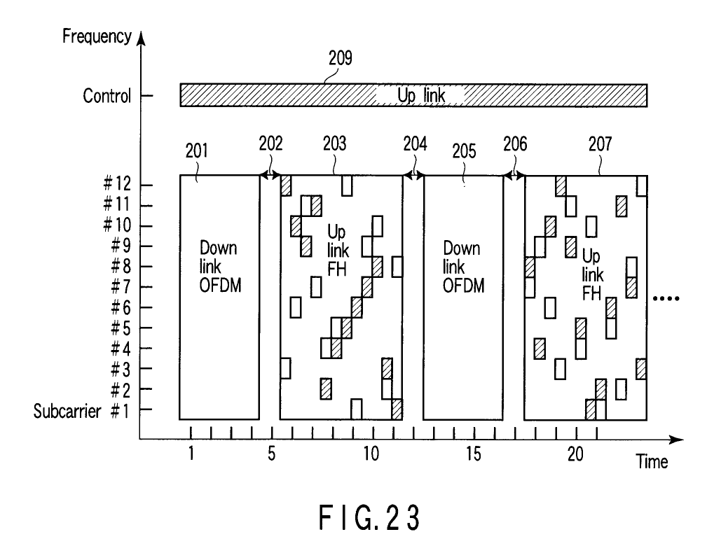

FIG. 22 shows an example of the arrangement of the terminals TE1 and TE2. Note that the same reference numerals in FIG. 22 denote the same parts as those in FIG. 19, and only characteristic features of this embodiment will be described below. Data to be transmitted from the terminal to the base station is converted into an FH signal by an FH transmitter unit 51. A hopping pattern at that time is based on FH pattern information received in the immediately preceding down slot. The FH transmitter unit 51 performs modulation at a timing based on a synchronization signal output from a CDMA receiver unit 63. The FH signal output from the FH transmitter unit 51 is band-limited by a band-pass filter (BPF) 60, and is then transmitted to the base station BS1 via a radio unit 58.

Upon completion of transmission of the FH signal, each of the terminals TE1 and TE2 begins to receive an OFDM signal transmitted from the base station BS1 using the down slot. The OFDM signal is received by a radio unit 57, and is converted into a digital signal. The digital signal is then converted into a band-limited received signal via a band-pass filter (BPF) 59. An OFDM receiver unit 53 modulates the band-limited received signal, and outputs subcarrier signals. At this time, the OFDM receiver unit 53 performs the modulation process on the basis of a synchronization signal output from the CDMA receiver unit 63.

Furthermore, in the terminal, a radio unit 61 receives a control signal transmitted in the down link of the control signal dedicated frequency band 208. The radio unit 61 applies frequency conversion and A/D conversion to the received signal, and outputs the converted signal to a band-pass filter (BPF) 62. The BPF 62 extracts a signal corresponding to the control signal dedicated frequency band 208 from the received signal, and outputs it to the CDMA receiver unit 63. The CDMA receiver unit 63 demodulates the input signal using a predetermined spread code to obtain a synchronization signal and a paging signal in a stand-by state.

According to the radio communication system that do TDD two-way communications, i.e., a downstream OFDM communication and upstream FH communication, according to the second embodiment, a high-speed communication is allowed in the down link and the peak power of the terminal side can be suppressed in an upstream communication, thus saving power consumption of the terminal. Since two-way communications of the OFDM and FH signals are made by time multiplexing, the base station can estimate the transmission channel characteristics of respective subcarriers for respective terminals on the basis of the FH signals transmitted from the respective terminals in the up slot, thus improving the transmission efficiency. Furthermore, in the second embodiment, a low-speed control signal is transmitted using the downstream control signal frequency band 208 from the base station to each terminal independently of the frequency bands used in the two-way communications. Therefore, since each terminal can execute the synchronization process, paging process, and the like without any reception process of an OFDM signal, low power consumption in a stand-by state or the like can be realized.

### THIRD EMBODIMENT

A schematic arrangement of a whole radio communication system according to the third embodiment is the same as that in the second embodiment.

FIG. 23 shows a slot format example of the radio communication system according to the third embodiment. A base station BS1 transmits data using OFDM to respective terminals using a frequency-time region 201 (subcarriers #1 to #12 and times “1” to “4”). After a guard time 202 elapses upon completion of transmission of the downstream OFDM signal by the base station BS1, each terminal transmits an FH signal using a hopping pattern which is determined in advance with the base station within the range of a frequency-time region 203 (subcarriers #1 to #12 and times “6” to “11”). Note that a hopping pattern that is distributed across all the frequencies (subcarriers #1 to #12) is preferably used in one up slot.

After a guard time 204 elapses upon completion of transmission of the upstream FH signal by each terminal, the base station transmits an OFDM signal again using a frequency-time region 205. In this way, the downstream OFDM signals and upstream FH signals are time multiplexed using identical frequency bands.

Each of terminals TE1 and TE2 transmits a signal (control signal) used in transmission power control, location registration of each terminal, and the like using a frequency band (control signal dedicated frequency band) 209 which is different from those used by the downstream OFDM signals and upstream FH signals.

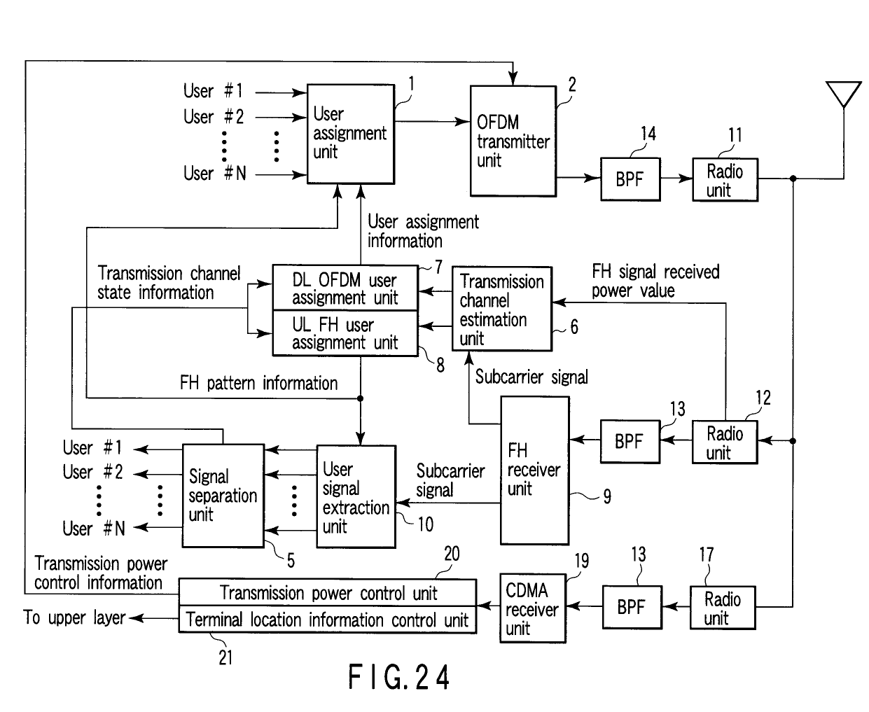

FIG. 24 shows an example of the arrangement of the base station BS1. Note that the same reference numerals in FIG. 24 denote the same parts as those in FIGS. 18 and 21, and only characteristic features of this embodiment will be described below. Data, FH pattern information, and user assignment information to be transmitted to respective users are multiplexed and sorted by a user assignment unit 1, and are output to an OFDM transmitter unit 2. The signals addressed to the respective users are converted into an OFDM signal by the OFDM transmitter unit 2, and the OFDM signal is output from a radio unit 11 after it is band-limited by a band-pass filter (BPS) 14.

At this time, the OFDM transmitter unit 2 adjusts the transmission power of each subcarrier signal using transmission power control information output from a transmission power control unit 20.

Upon completion of transmission of a downstream OFDM signal, an FH signal from each terminal is received by a radio unit 12. A signal output from the radio unit 12 is converted into a band-limited signal via a band-pass filter (BPF) 13, and the band-limited signal is input to an FH receiver unit 9.

The FH receiver unit 9 detects subcarrier signals from the received signal output from the radio unit 12. The subcarrier signals are output to a transmission channel estimation unit 6 and user signal extraction unit 10.

The transmission channel estimation unit 6 measures the transmission channel characteristics such as the transmission channel distortions, power values, power ratios, and the like for respective subcarrier signals for each terminal on the basis of the subcarrier signals and the received power value of the FH signal measured by the radio unit 12 for AGC. The transmission channel characteristics of an up link from each terminal to the base station estimated by the transmission channel estimation unit 6 are output to a DL OFDM user assignment unit 7 and UL FH user assignment unit 8. Then, the DL OFDM user assignment unit 7 and UL FH user assignment unit 8 use the transmission channel characteristics in order to assign channels to respective terminals in the down and up links.

In the base station BS1, a radio unit 17 receives a control signal transmitted in the up link of the control signal dedicated frequency band 209. The radio unit 17 applies frequency conversion and A/D conversion to the received signal and outputs it a band-pass filter (BPF) 18. The BPF 18 extracts a signal corresponding to the control signal dedicated frequency band 209 from the received signal, and outputs the extracted signal to a CDMA receiver unit 19. The CDMA receiver unit 19 demodulates the input signal using a predetermined spread code, and outputs the demodulated control signal to the transmission power control unit 20 and a terminal location information registration unit 21.

The transmission power control unit 20 outputs transmission power control information to the radio unit 11 so as to control the transmission power of the next down slot using the power values and power ratios of subcarriers included in the control signal, which are obtained by demodulating the control signal transmitted from each terminal. For example, when the power value (power ratio) of each subcarrier is smaller than a predetermined first threshold value, the unit 20 increases the current transmission power by a predetermined value. On the other hand, when the power value (power ratio) of each subcarrier is equal to or larger than a predetermined second threshold value, the unit 20 decreases the current transmission power by a predetermined value. When the power value (power ratio) of each subcarrier falls within the range between the predetermined first threshold value (inclusive) and the second threshold value (exclusive), the unit 20 controls not to change the transmission power.

The terminal location information registration unit 21 informs an upper layer of location registration information included in the control signal, which is obtained by demodulating the control signal transmitted from each terminal, so as to use it in a hand-over process or the like.

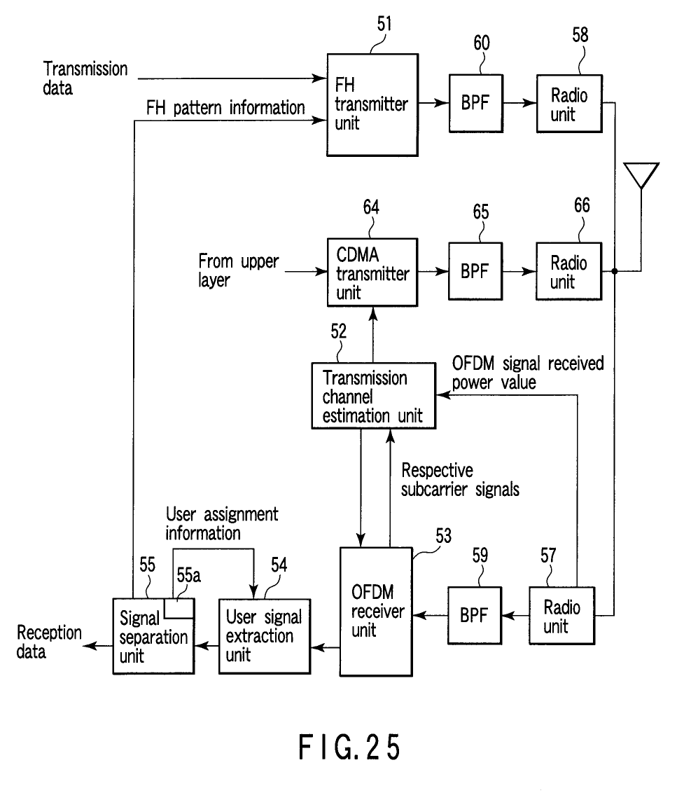

FIG. 25 shows an example of the arrangement of the terminals TE1 and TE2. Note that the same reference numerals in FIGS. 19 and 22 denote the same parts as those in FIG. 25, and only characteristic features of this embodiment will be described below. Data to be transmitted from the terminal to the base station is converted into an FH signal by an FH transmitter unit 51. A hopping pattern at that time is based on FH pattern information received in the immediately preceding down slot. The FH signal output from the FH transmitter unit 51 is band-limited by a band-pass filter (BPF) 60, and is then transmitted to the base station BS1 via a radio unit 58.

Upon completion of transmission of the FH signal, the terminal begins to receive an OFDM signal transmitted from the base station BS1 using the down slot. The OFDM signal is received by a radio unit 57, and is converted into a digital signal. The digital signal is then converted into a band-limited received signal via a band-pass filter (BPF) 59. An OFDM receiver unit 53 modulates the band-limited received signal, and outputs subcarrier signals.

The terminal further transmits a control signal using the up link of the control signal dedicated frequency band 209. In FIG. 25, information for location registration from the upper layer (location registration information) and the power values and power ratios of respective subcarriers obtained by a transmission channel estimation unit 52 undergo CDMA multiplex, spread, and modulation processes by a CDMA transmitter unit 64, thus outputting a CDMA signal. The CDMA signal is output to a radio unit 66 via a band-pass filter (BPF) 65 corresponding to the control signal dedicated frequency band 209. The CDMA signal input to the radio unit 66 undergoes D/A conversion, frequency conversion, and the like, and is transmitted via an antenna.

According to the radio communication system of the third embodiment, a high-speed communication is allowed in the down link and the peak power of the terminal side can be suppressed in an upstream communication, thus saving power consumption of the terminal. Since two-way communications of the OFDM and FH signals are made by time multiplexing, the transmission channel characteristics can be estimated from each other's data signals, thus improving the transmission efficiency. Furthermore, in the third embodiment, a control signal is transmitted using the upstream control signal dedicated frequency band 209 from each terminal to the base station independently of the frequency bands used in the two-way communications. Therefore, since each terminal can inform control information such as transmission power control, location registration information, and the like without any negotiation process of a frequency hopping pattern between the base station and terminal, the processing volume in the base station can be reduced.

### FOURTH EMBODIMENT

A schematic arrangement of a whole radio communication system according to the fourth embodiment is the same as that in the second embodiment.

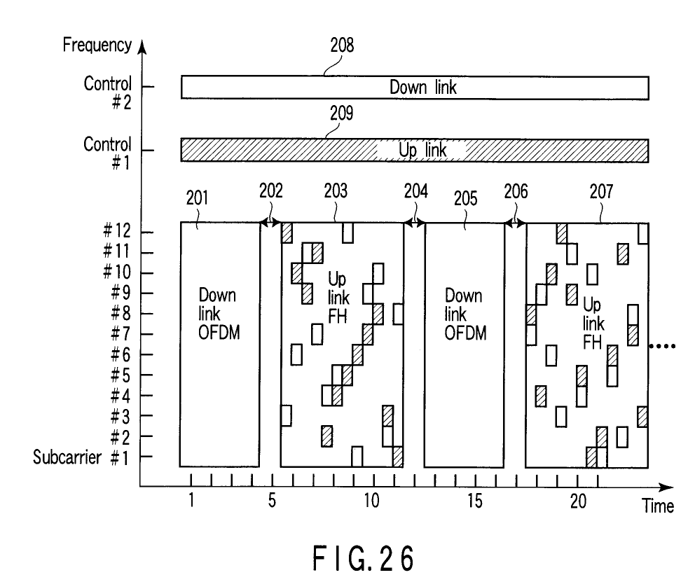

FIG. 26 shows a slot format example of the radio communication system according to the fourth embodiment. The same reference numerals in FIG. 26 denote the same parts as in FIG. 23 of the third embodiment, and only differences will be explained below. That is, in FIG. 26, the control signal dedicated frequency band 208 described in the second embodiment is assured in addition to the control signal dedicated frequency band 209 described in the third embodiment. Each terminal transmits a first control signal including at least one of signals used in transmission power control, location registration of each terminal and the like to the base station using the control signal dedicated frequency band 209. The base station transmits, to each terminal, a second control signal including at least one of a time synchronization signal and paging signal using the control signal dedicated frequency band 208 which is different from the control signal dedicated frequency band 209.

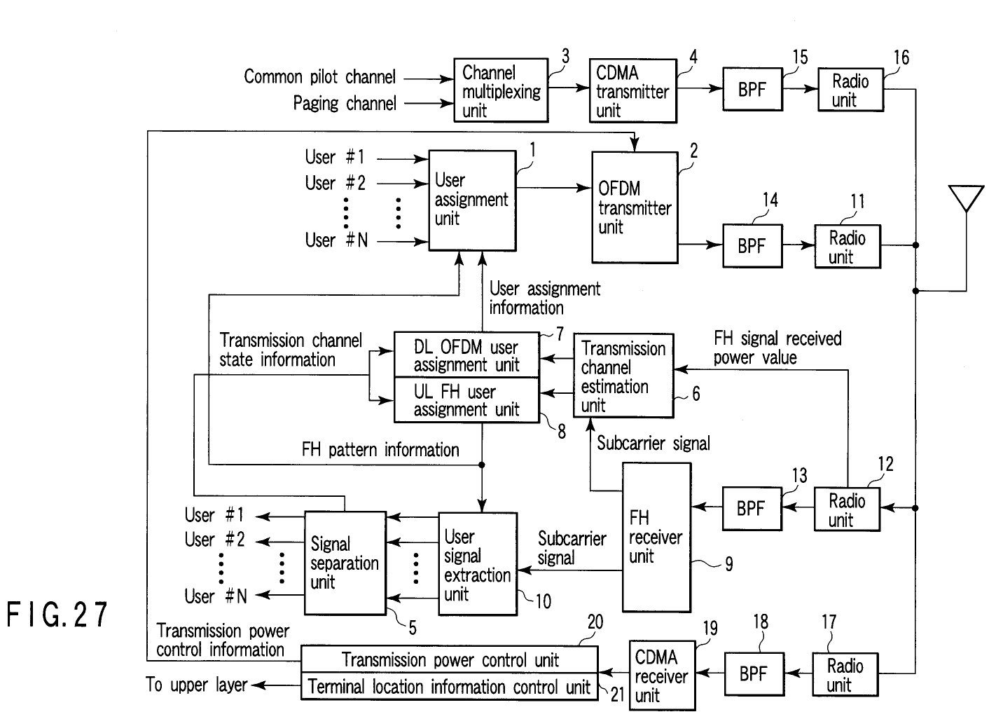

FIG. 27 shows an example of the arrangement of a base station BS1 according to the fourth embodiment. Note that the same reference numerals in FIG. 27 denote the same parts as those in FIGS. 21 and 24, and only differences will be described below.

The base station according to the fourth embodiment has a channel multiplexing unit 3, CDMA transmitter unit 4, BPF 15, and radio unit 16 required to transmit the second control signal (common pilot channel, paging channel) using the control signal dedicated frequency band 208, as described in the second embodiment.

Furthermore, as described in the third embodiment, the base station has a radio unit 17, BPF 18, CDMA receiver unit 19, transmission power control unit 20, and terminal location information registration unit 21 required to receive the first control signal transmitted using the up link of the control signal dedicated frequency band 209, as described in the third embodiment.

An OFDM transmitter unit 2 adjusts the transmission power of subcarriers to each terminal on the basis of transmission power control information output from the transmission power control unit 20.

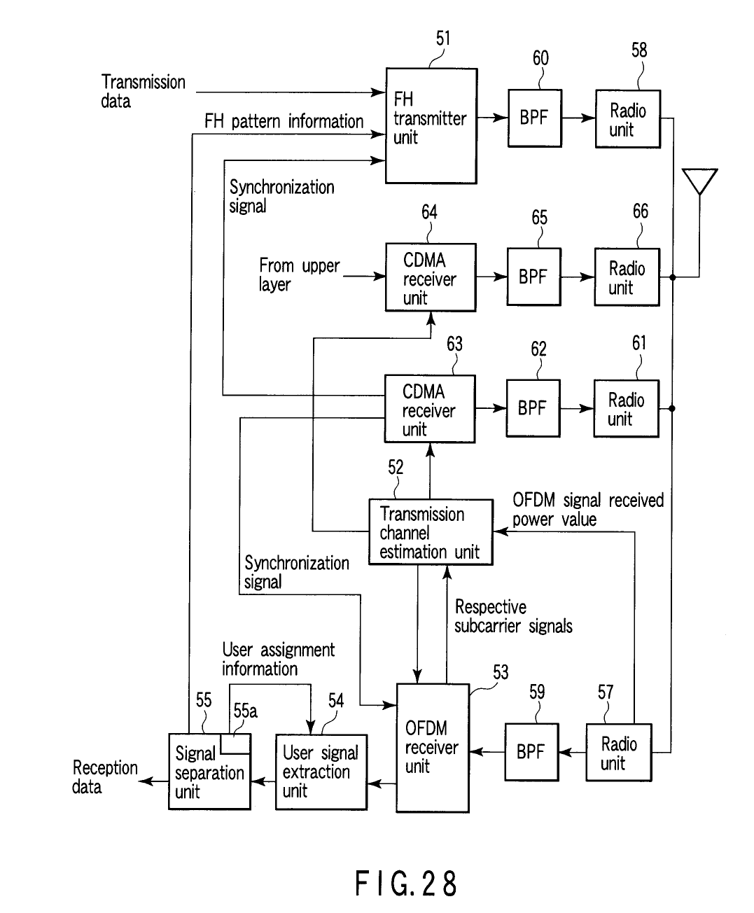

FIG. 28 shows an example of the arrangement of terminals TE1 and TE2. Note that the same reference numerals in FIG. 28 denote the same parts as in FIGS. 22 and 25, and only differences will be described below.

The terminal according to the fourth embodiment has a radio unit 61, BPF 62, and CDMA receiver unit 63 required to receive the second control signal (common pilot channel, paging channel) transmitted from the base station using the control signal dedicated frequency band 208, as described in the second embodiment. An FH transmitter unit 51 performs modulation at a timing on the basis of a synchronization signal output from the CDMA receiver unit 63. An OFDM receiver unit 53 performs a modulation process at a timing on the basis of a synchronization signal output from the CDMA receiver unit 63.

Furthermore, the terminal has a CDMA transmitter unit 64, BPF 65, and radio unit 66 required to transmit the first control signal using the up link of the control signal dedicated frequency band 209.

According to the radio communication system of the fourth embodiment, a high-speed communication is allowed in the down link and the peak power of the terminal side can be suppressed in an upstream communication, thus saving power consumption of the terminal. Since two-way communications of the OFDM and FH signals are made by time multiplexing, the transmission channel characteristics can be estimated from each other's data signals, thus improving the transmission efficiency. Furthermore, in the fourth embodiment, the first control signal is transmitted using the upstream control signal dedicated frequency band 209 from each terminal to the base station independently of the frequency bands used in the two-way communications. Therefore, since each terminal can inform control information such as transmission power control, location registration information, and the like without any negotiation process of a frequency hopping pattern between the base station and terminal, the processing volume in the base station can be reduced. Moreover, in the fourth embodiment, the low-speed second control signal is transmitted using the downstream control signal frequency band 208 from the base station to each terminal independently of the frequency bands used in the two-way communications. Therefore, since each terminal can execute the synchronization process, paging process, and the like without any reception process of an OFDM signal, low power consumption in a stand-by state or the like can be realized. In this manner, since the upstream control signal dedicated frequency band 209 and downstream control signal dedicated frequency band 208 are assured, low power consumption in a stand-by state of each terminal, and a reduction effect of the processing volume of the base station can be achieved.

### FIFTH EMBODIMENT

In the fifth and sixth embodiments, a case will be explained wherein the communication speed ratio between the up and down radio links is to be changed on the basis of a data size to be transmitted from each terminal to the base station and that to be transmitted from the base station to each terminal.

A schematic arrangement of a whole radio communication system according to the fifth embodiment will be described below with reference to FIG. 2. A base station BS1 transmits downstream OFDM signals DL1 and DL2 to terminals TE1 and TE2 for a predetermined period of time. Upon completion of transmission of the downstream OFDM signals by the base station BS1, the terminals TE1 and TE2 transmit upstream FH signals UL1 and UL2 using the same frequency bands as the downstream OFDM signals to the base station BS1. In this way, the downstream OFDM signals and upstream FH signals are temporally multiplexed. In the radio communication system according to the fifth embodiment, the communication speed ratio between the downstream OFDM signals and upstream FH signals can be dynamically changed by changing a time slot format.

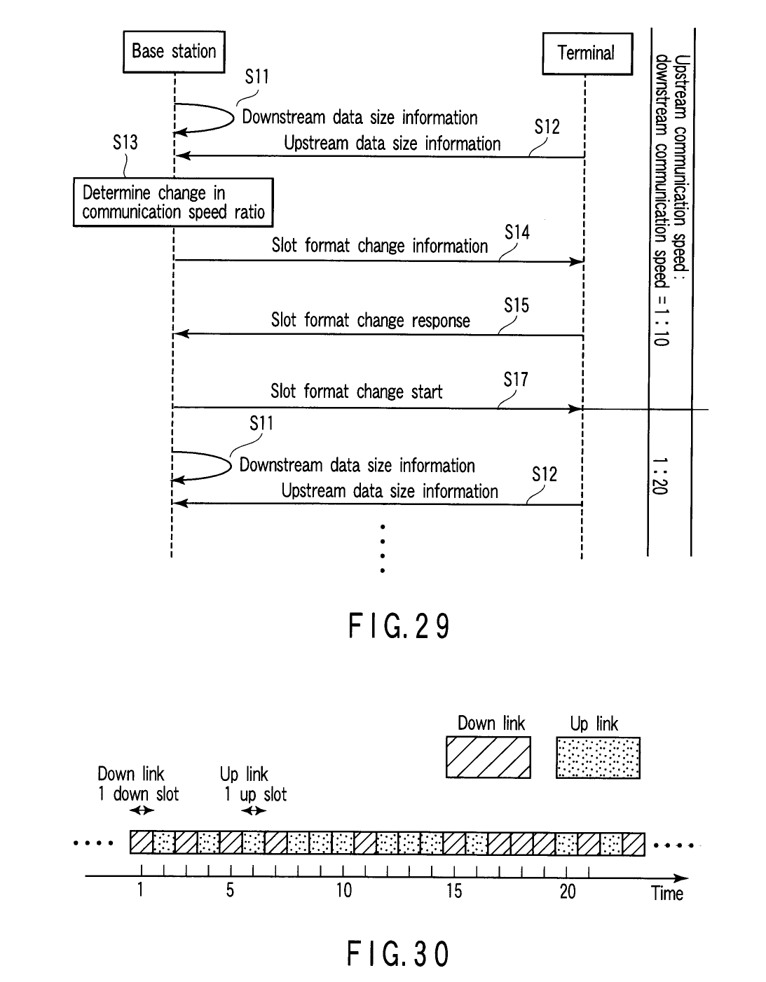

FIG. 29 is a flowchart showing the processing sequence for changing the communication speed ratio between the base station and each terminal. The base station monitors a data size to be transmitted from the base station to each terminal at given intervals (step S11). Each terminal notifies a data size to be transmitted from that terminal to the base station (step S12). The data size information is sent from the terminal to the base station using, e.g., an FH signal in the up link.

If the base station determines based on these pieces of information that the balance between the data size to be transmitted in the up link and that to be transmitted in the down link is largely different from the current communication speed ratio, it determines a communication speed ratio to be changed (step S13). For example, assume that the current ratio between the upstream and downstream communication speeds is 1:10. However, since the data size to be transmitted in the down link increases, the ratio between the upstream and downstream communication speeds is to be changed to 1:20 in FIG. 29.

The base station transmits slot format change information to each terminal (step S14). The terminal receives the slot format change information, and starts preparation for it. Upon completion of slot format change preparation, the terminal returns a response signal to the slot format change information to the base station (step S15).

After all the communicating terminals have returned the response signals to the slot format change information, the base station transmits a slot format change start signal, and changes a slot format at the same time, thus changing the communication speed ratio (step S17).

In this way, the base station checks if the communication speed ratio is to be changed, by always monitoring the data sizes in the down and up links.

In the radio communication system that do TDD two-way communications, i.e., a downstream OFDM communication and upstream FH communication, each terminal can estimate the transmission channel states of all the frequency bands used in two-way communications. Since the peak average power can be reduced using the FH communication scheme in the up link, the power consumption of the terminal can be saved. Furthermore, since the upstream and downstream communications are temporally multiplexed, each other's transmission channel characteristic estimation values can be used, and negotiation between the base station and each terminal can be relatively easily determined with a sufficient time margin. Also, since the slot format is changed using negotiation, system resources can be effectively utilized.

The state wherein the slot format changes will be described in detail below with reference to FIG. 30. In FIG. 30, the base station transmits downstream OFDM signals to each terminal using times “1”, “3”, “5”, . . . . Also, each terminal transmits upstream FH signals to the base station using times “2”, “4”, “6”, . . . . In an FH signal in an up link at time “4”, a data size to be transmitted by the terminal is transmitted. Assume that the base station determines a change in communication speed ratio in consideration of the data size received from each terminal and the data size in the down link to be transmitted to each terminal.

The base station transmits slot format change information to each terminal in a down link at time “5”, and each terminal transmits a response signal to the slot format change information in an up link at time “6”. After the base station confirms that all the currently communicating terminals transmit the response signals, it transmits a slot format change start signal to each terminal in a down link at time “7”.

In FIG. 30, one up slot and one down slot are alternately transmitted to attain time multiplexing before the slot format is changed. After time “8”, three up slots and one down slot are alternately transmitted, thus improving the upstream communication speed. Conversely, since three down slots are successively transmitted from time “17” to time “19”, the downstream communication speed is improved.

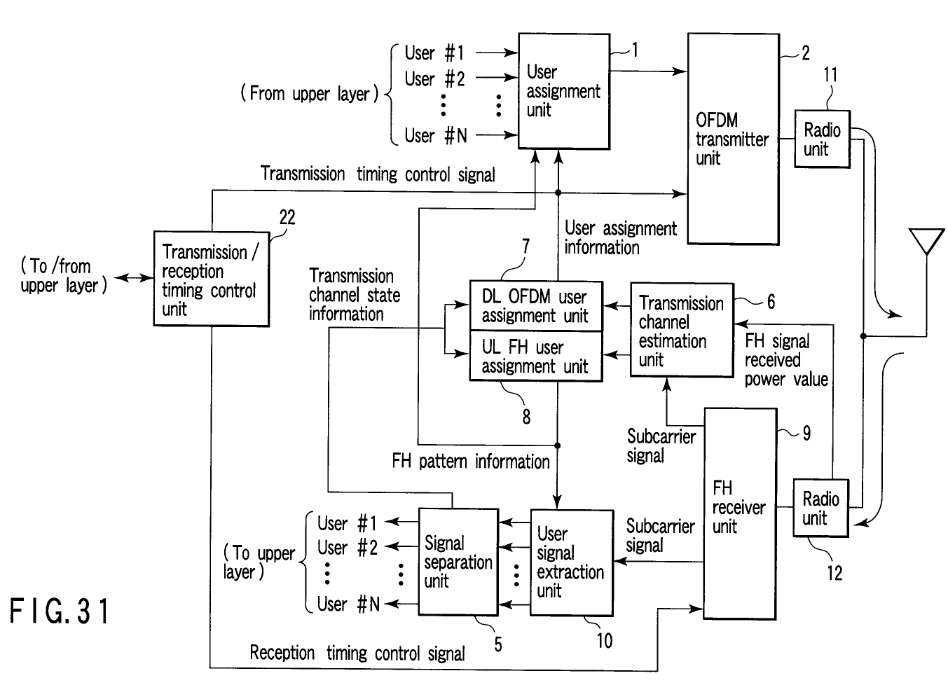

FIG. 31 shows an example of the arrangement of the base station according to the fifth embodiment. Note that the same reference numerals in FIG. 31 denote the same parts as in FIG. 18, and only differences will be explained. That is, in FIG. 31, a transmission/reception timing control unit 22 is newly added.

From each terminal, upstream data size information to be transmitted is sent using an FH signal. This upstream data size information is passed from a signal separation unit 5 to an upper layer.

When it is determined based on the upstream data size periodically sent from each terminal and the data size to be transmitted from the base station to each terminal that the communication speed ratio is to be changed, the upper layer generates slot format change information used to notify each terminal of a timing at which the communication speed ratio is to be changed, and the communication speed ratio itself, and transmits that information to each terminal using an OFDM signal. Since each terminal transmits a slot format change response using an FH signal, that response is received by the upper layer. After the slot format change responses are received from all communicating terminals, the upper layer supplies a slot format change start signal to be transmitted to each terminal to a user assignment unit 1 so as to transmit it as an OFDM signal. At the same time, the upper layer supplies a change timing and communication speed ratio to the transmission/reception timing control unit 22.

The transmission/reception timing control unit 22 calculates the slot format to attain a desired communication speed ratio, and outputs transmission and reception timing control signals to an OFDM transmitter unit 2 and FH receiver unit 9 so as to set the transmission and reception timings corresponding to the slot format.

The output timing of an OFDM signal from the OFDM transmitter unit 2 is determined with reference to the transmission timing control signal output from the transmission/reception timing control unit 22. The timing of a reception process to be executed by the FH receiver unit 9 is determined with reference to the reception timing control signal output from the transmission/reception timing control unit 22.

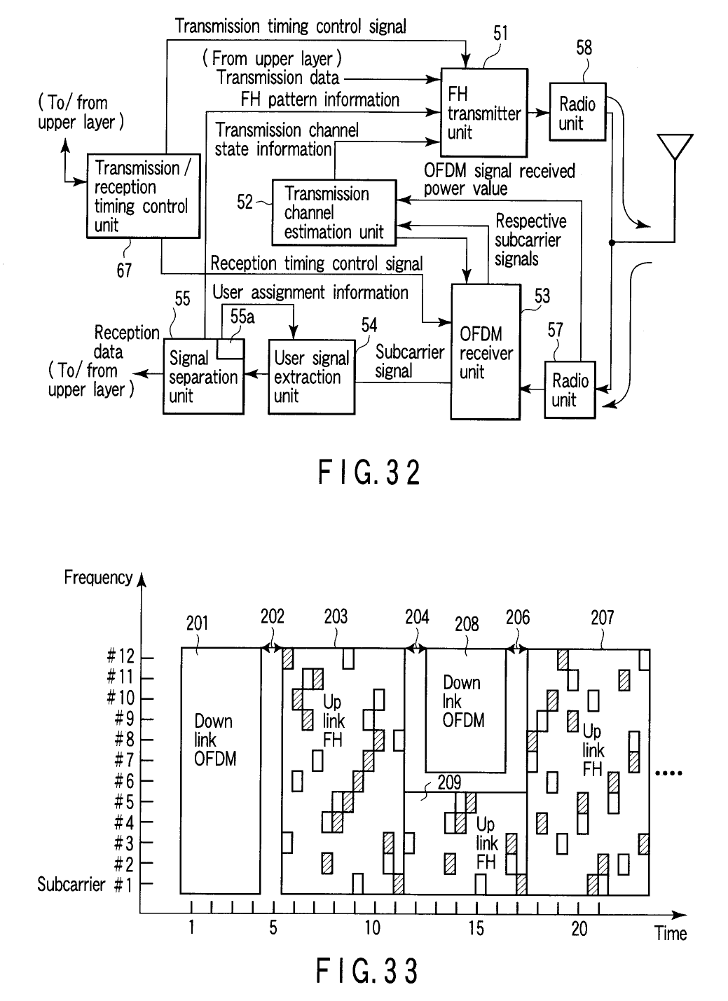

FIG. 32 shows an example of the arrangement of the terminal according to the fifth embodiment. Note that the same reference numerals in FIG. 32 denote the same parts as in FIG. 19, and only differences will be explained. That is, a transmission/reception timing control unit 67 is newly added in FIG. 32.

An upper layer supplies upstream data size information to an FH transmitter unit 51 so as to periodically transmit that information to the base station. The FH transmitter unit 51 modulates the upstream data size information to an FH signal, and transmits the FH signal to the base station as in the above description. An OFDM signal transmitted from the base station using a down slot is processed by an OFDM receiver unit 53, user signal extraction unit 54, and signal separation unit 55, and only received data addressed to the self terminal is passed to the upper layer, as described above. If this received data includes slot format change information, the upper layer supplies slot format change response information to be transmitted to the base station to the FH transmitter unit 51 so as to transmit it as an FH signal. At the same time, the upper layer supplies the change timing and communication speed ratio included in the slot format change information to the transmission/reception timing control unit 67.

The transmission/reception timing control unit 67 calculates a slot format to attain the desired communication speed ratio, and outputs transmission and reception control signals to the FH transmitter unit 51 and OFDM receiver unit 53 so as to set the transmission and reception timings corresponding to that slot format.

The output timing of the OFDM transmitter unit 51 is determined with reference to the transmission timing control signal output from the transmission/reception timing control unit 67. The reception timing of an OFDM signal by the OFDM receiver unit 53 is determined with reference to the reception timing control signal output from the transmission/reception timing control unit 67.

As described above, according to the fifth embodiment, by changing the slot format (i.e., by changing the transmission duration of an OFDM signal and that of an FH signal), the system resources can be effectively utilized. Also, the communication speed ratio can be changed without largely modifying an existing system arrangement.

### SIXTH EMBODIMENT

In the fifth embodiment, the communication speed ratio between the up and down ratio links is changed by changing the transmission duration of an OFDM signal and that of an FH signal. That is, the upstream/downstream communication speed ratio is changed by changing the slot format, i.e., from one time slot each used to transmit OFDM and FH signals to two or three successive time slots to transmit an OFDM signal and one time slot to transmit an FH signal.

The sixth embodiment will explain another method of changing the upstream/downstream communication speed ratio. That is, a case will be explained below wherein transmission of some subcarriers of an OFDM signal is stopped, and an FH signal is transmitted using the transmission-stopped frequency bands and times, thus changing the upstream/downstream communication speed ratio. In this embodiment, a case will be explained wherein the upstream/downstream communication speed ratio is changed by combining this method and the aforementioned fifth embodiment. However, the upstream/downstream communication speed ratio can be changed using either one of these methods.

FIG. 33 shows a slot format example used in the radio communication system according to the sixth embodiment. The base station transmits data using OFDM to respective terminals using a frequency-time region 201 (subcarriers #1 to #12 and times “1” to “4”). After a guard time 202 elapses upon completion of transmission of the downstream OFDM signal by the base station BS1, each terminal transmits an FH signal using a hopping pattern which is determined in advance with the base station within the range of a frequency-time region 203 (subcarriers #1 to #12 and times “6” to “11”).

After that, the base station stops data transmission of subcarriers #1 to #6 and transmits data using a frequency range of subcarriers #7 to #12 in a downstream OFDM slot from time “13” to time “16”. At this time, each terminal transmits an FH signal to the base station using a frequency-time region 209 (subcarriers #1 to #5 and times “11” to “17”). Hence, the base station performs transmission while receiving data from time “13” to time “16”. The terminal arrangement can be simplified when the terminal performs only transmission or reception of data.

As described above, in the radio communication system according to the sixth embodiment, since the frequency bands to be assigned to each user are limited in the down link (by forming the transmission-stopped frequency-time region 209 in a downstream communication), an upstream OFDM communication is made using the frequency-time region of subcarriers which are not used in the downstream communication.

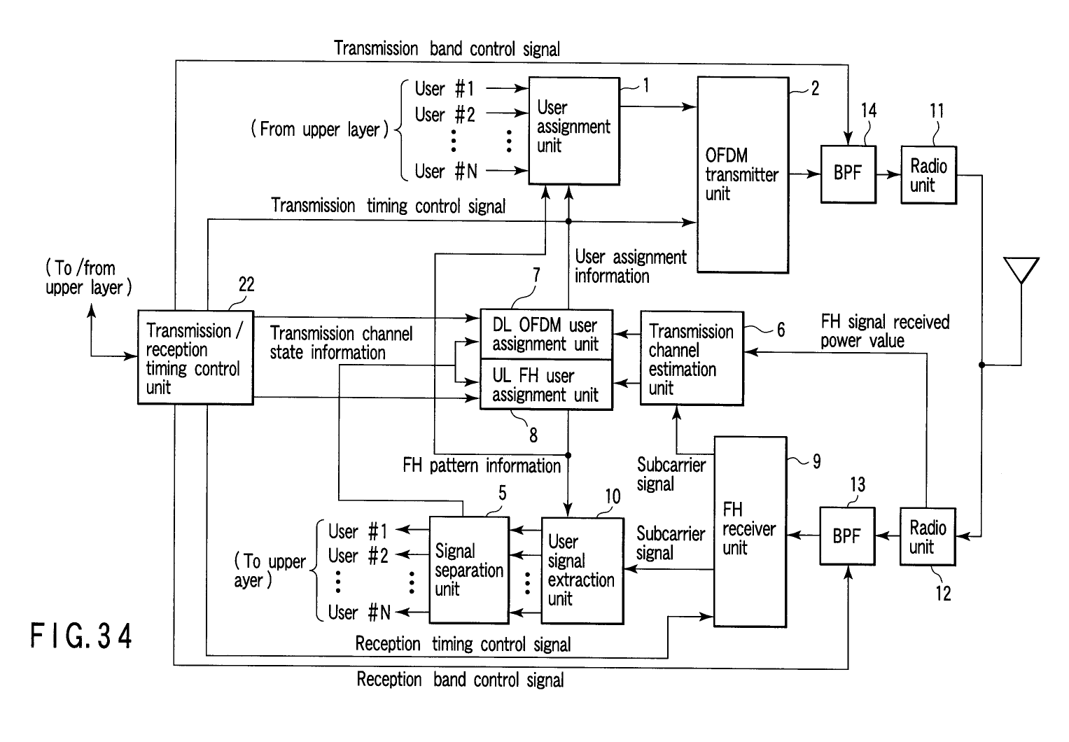

FIG. 34 shows an example of the arrangement of the base station according to the sixth embodiment. Note that the same reference numerals in FIG. 34 denote the same parts as in FIG. 31 that shows the arrangement of the base station in the fifth embodiment, and only differences will be explained. That is, in FIG. 34, a band-pass filter (BPF) 14 is connected between an OFDM transmitter unit 2 and radio unit 11, and a band-pass filter (BPF) 13 is connected between a radio unit 12 and FH receiver unit 9.

When it is determined based on the upstream data size periodically sent from each terminal and the data size to be transmitted from the base station to each terminal that the communication speed ratio is to be changed, an upper layer generates slot format change information used to notify each terminal of the change timing of the communication speed ratio, the communication speed ratio itself, and the frequency bands and times in which reception of an OFDM signal is stopped (or used to receive an OFDM signal), or of the change timing of the communication speed ratio, the communication speed ratio itself, and the frequency bands and times used to transmit an FH signal, and transmits that information to each terminal using an OFDM signal. Since each terminal transmits a slot format change response using an FH signal, that response is received by the upper layer. After the slot format change responses are received from all communicating terminals, the upper layer supplies a slot format change start signal to be transmitted to each terminal to a user assignment unit 1 so as to transmit it as an OFDM signal. At the same time, the upper layer notifies a transmission/reception timing control unit 22 of a change timing, the communication speed ratio, the frequency bands and times in which reception of an OFDM signal is stopped (or used to receive an OFDM signal), and the frequency bands and time used to transmit an FH signal.

Upon reception of the change timing of the communication speed ratio and the communication speed ratio itself to be changed from the upper layer, the transmission/reception timing control unit 22 calculates the slot format to attain a desired communication speed ratio, and outputs transmission and reception timing control signals to the OFDM transmitter unit 2 and FH receiver unit 9 so as to set the transmission and reception timings corresponding to the slot format. Also, the unit 22 outputs, to the BPFs 14 and 13, transmission and reception band control signals used to notify the frequency bands and times in which reception of an OFDM signal is stopped (or used to receive an OFDM signal), which is notified from the upper layer.

The output timing of an OFDM signal from the OFDM transmitter unit 2 is determined with reference to the transmission timing control signal output from the transmission/reception timing control unit 22. The BPF 14 is notified of the frequency bands in which transmission is to be stopped (or used to perform transmission) on the basis of the transmission band control signal output from the transmission/reception timing control unit 22. The BPF 14 band-limits an OFDM signal output from the OFDM transmitter unit 2 with reference to this transmission band control signal.

The timing of a reception process to be executed by the FH receiver unit 9 is determined with reference to the reception timing control signal output from the transmission/reception timing control unit 22. The BPF 13 is notified of the frequency bands used to perform reception (or those which do not perform reception) on the basis of the reception band control signal output from the transmission/reception timing control unit 22. The BPF band-limits an FH signal to be received by the FH receiver unit 9 with reference to this reception band control signal.

With this arrangement, the OFDM transmitter unit 2 stops data transmission of subcarriers #1 to #6 in a downstream OFDM slot from time “13” to time “16” in FIG. 33, and transmits an OFDM signal using a frequency range of subcarriers #7 to #12. On the other hand, the FH receiver unit 9 receives an FH signal transmitted from each terminal using subcarriers #1 to #5 from time “11” to time “17” in FIG. 33.

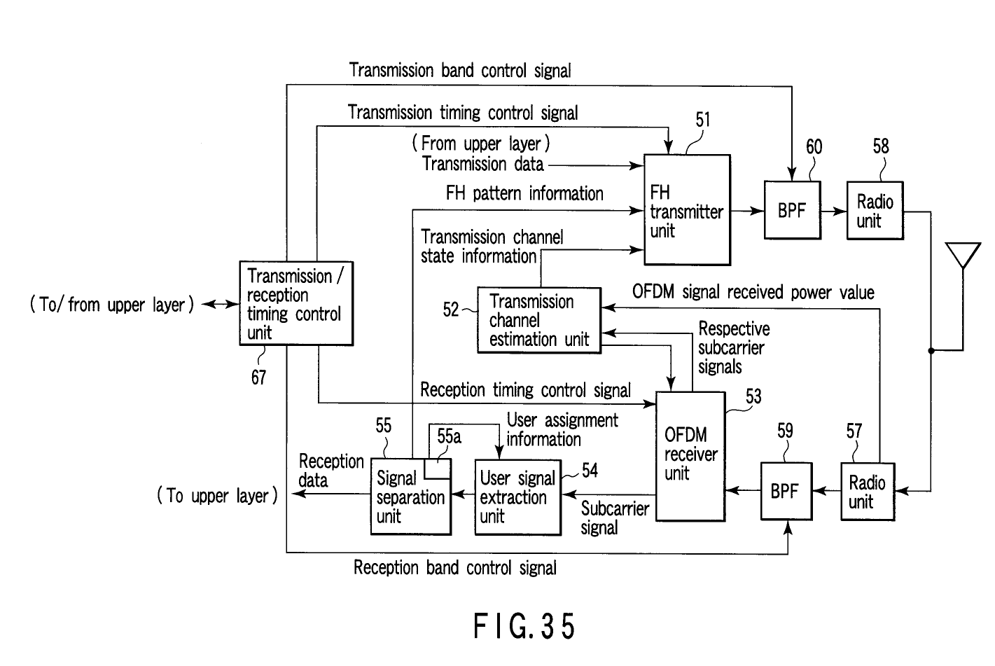

FIG. 35 shows an example of the arrangement of the terminal according to the sixth embodiment. Note that same reference numerals in FIG. 35 denote the same parts as in FIG. 32 that shows the arrangement of the terminal according to the fifth embodiment, and only differences will be explained. That is, in FIG. 35, a band-pass filter (BPF) 60 is connected between an FH transmitter unit 51 and radio unit 58, and a band-pass filter (BPF) 59 is connected to a radio unit 57 and OFDM receiver unit 53.

Upon reception of the slot format change information, an upper layer supplies the change timing of the communication speed ratio, the communication speed ratio itself after change, and the frequency bands and times in which reception of an OFDM signal is to be stopped (or used to receive an OFDM signal), or the change timing of the communication speed ratio, the communication speed ratio itself after change, and the frequency bands and times used to transmit an FH signal, which are included in the slot format change information, to a transmission/reception timing control unit 67.

Upon reception of the change timing of the communication speed ratio and the communication speed ratio itself to be changed from the upper layer, the transmission/reception timing control unit 67 outputs transmission and reception timing control signals to the FH transmitter unit 51 and OFDM receiver unit 53 so as to attain transmission and reception timings corresponding to the slot format that can attain the desired communication speed ratio. Also, the unit 67 outputs, to the BPFs 60 and 59, transmission and reception band control signals used to notify the frequency bands and times in which reception of an OFDM signal is to be stopped (or used to receive an OFDM signal), or the frequency bands and times used to transmit an FH signal.

The output timing of the OFDM transmitter unit 51 is determined with reference to the transmission timing control signal output from the transmission/reception timing control unit 67. The BPF 60 is notified of the frequency bands in which transmission is to be stopped (or those which are used to perform transmission) on the basis of the transmission band control signal output from the transmission/reception timing control unit 67. The BPF 60 band-limits an FH signal output from the FH transmitter unit 51 with reference to this transmission band control signal.

The timing of a reception process to be executed by the OFDM receiver unit 53 is determined with reference to the reception timing control signal output from the transmission/reception timing control unit 67. The BPF 59 is notified of the frequency bands used to perform reception (or those which are not used to perform reception) on the basis of the reception band control signal output from the transmission/reception timing control unit 67. The BPF 59 band-limits an OFDM signal to be received by the OFDM receiver unit 53 with reference to this reception band control signal.

With this arrangement, in the terminal, the FH transmitter unit 51 transmits an FH signal to the base station using subcarriers #1 to #5 from time “11” to time “17” in FIG. 33. Alternatively, the OFDM receiver unit 53 receive an OFDM signal including subcarriers #1 to #6 transmitted from the base station from time “13” to time “16” without transmitting any FH signal within this time band.

As described above, according to the sixth embodiment, the transmission speed of an upstream communication can be improved, and the communication speed ratio can be changed in more detail. Also, the communication speed ratio can be changed in more detail without largely modifying an existing system arrangement.

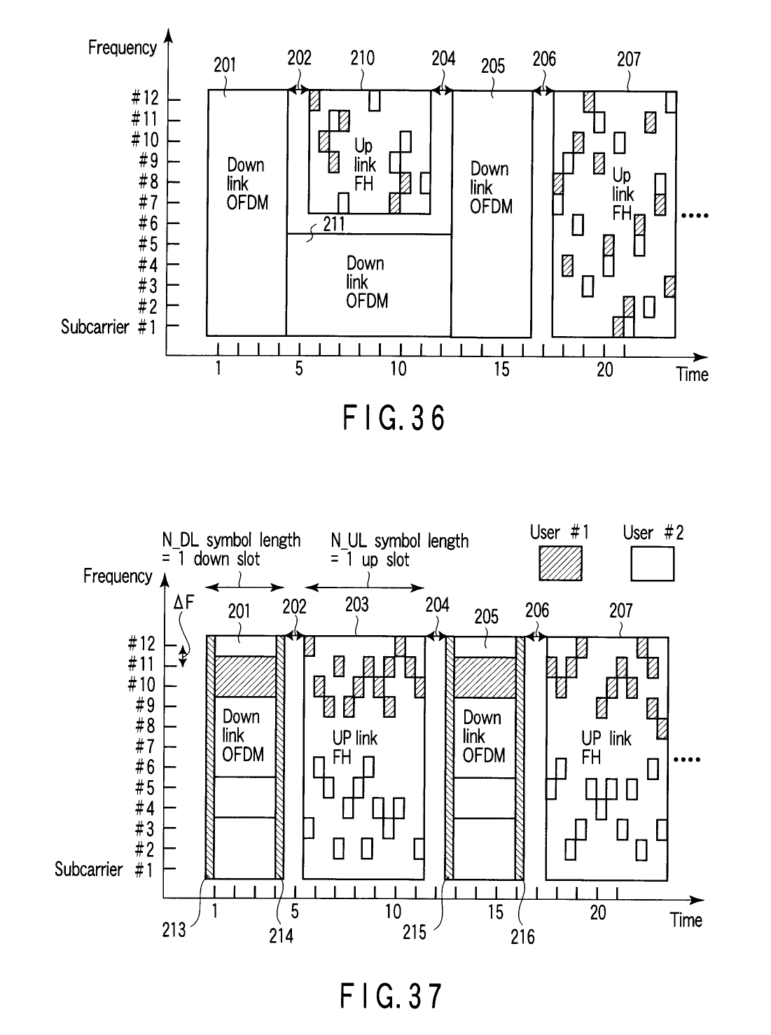

Note that FIG. 33 shows a case wherein the transmission-stopped frequency-time region is formed in the down link. However, as shown in FIG. 36, a transmission-stopped frequency-time region may be formed in an up link. In this case, the arrangements of the base station and terminal are the same as those in FIGS. 34 and 35.

In FIG. 36, the base station transmits data using OFDM to respective terminals using a frequency-time region 201 (subcarriers #1 to #12 and times “1” to “4”). After a guard time 202 elapses upon completion of transmission of the downstream OFDM signal by the base station, each terminal transmits an FH signal using a hopping pattern which is determined in advance with the base station within the range of a frequency-time region 210 (subcarriers #7 to #12 and times “6” to “11”). Note that a frequency-time region 211 (subcarriers #1 to #6 and times “5” to “12”) is used to transmit a downstream OFDM signal. Therefore, each terminal uses a hopping pattern that inhibits transmission in this region 211.

The base station transmits a downstream OFDM signal to each terminal using the frequency-time region 211 while receiving an upstream signal from each terminal in the frequency-time region 210. The terminal arrangement can be simplified when the terminal performs only transmission or reception of data. After a guard time 204 elapses upon completion of the upstream communication by each terminal at time “11”, the base station transmits data again using all subcarriers.

In FIG. 36, since a hopping pattern that limits the frequency bands in the up link is used (the transmission-stopped frequency-time region is formed in the up link), a downstream OFDM communication is done using the frequency-time region which is not used in the up link. With this slot format, the transmission speed of a downstream communication is improved, and the communication speed ratio can be changed in more detail.

### SEVENTH EMBODIMENT

A schematic arrangement of a whole radio communication system according to the third embodiment is the same as that in the second embodiment. That is, a base station BS1 transmits downstream OFDM signals DL1 and DL2 to terminals TE1 and TE2 for a predetermined period of time, as described in FIG. 2. Upon completion of transmission of the downstream OFDM signals by the base station, the terminals TE1 and TE2 transmit upstream FH signals UL1 and UL2 using the same frequency bands as the downstream OFDM signals to the base station BS1. In this way, the downstream OFDM signals and upstream FH signals are temporally multiplexed.

FIG. 37 shows a slot format applied to a radio communication system according to the seventh embodiment. The base station BS1 successively transmits data for N_DL symbols using OFDM to respective terminals using a frequency-time region 201 (subcarriers #1 to #12 and times “11” to “4”). At this time, the base station assigns pilot symbols known to both the base station and each terminal to an initial symbol 213 and terminal symbol 214 of successive symbols in one down slot.

In FIG. 37, data of user #1 is assigned to subcarriers #10 and #11, and data of user #2 is assigned to subcarriers #4 and #5. The base station BS1 assigns channels to respective users in a down slot by selecting subcarriers with a satisfactory transmission channel state to each user on the basis of the transmission channel estimation result using pilot symbols in the down slot (sent from the terminal).

After a guard time 202 elapses upon completion of transmission of the downstream OFDM signal by the base station, each terminal transmits an FH signal for N_UL symbols using a hopping pattern which is notified in advance from the base station within the range of a frequency-time region 203 (subcarriers #1 to #12 and times “6” to “11”).

In FIG. 37, since the transmission channel states in subcarriers #10 and #11 are good, user #1 uses a hopping pattern that mainly uses subcarriers #10 and #11. Also, since the transmission channel states in subcarriers #4 and #5 are good, user #2 uses a hopping pattern that mainly uses subcarriers #4 and #5.

After a guard time 204 elapses upon completion of transmission of the upstream FH signal by each terminal, the base station begins to transmit an OFDM signal to each terminal again.

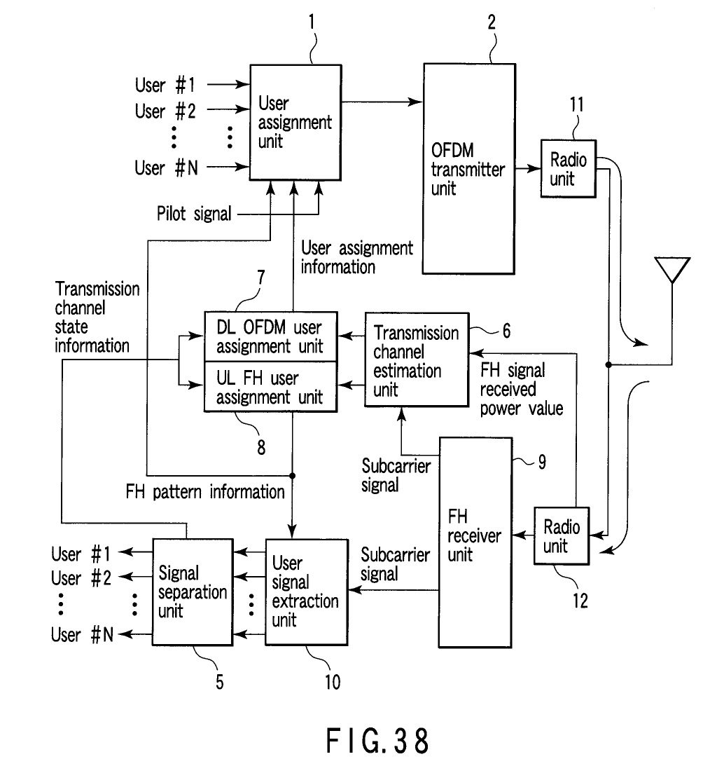

FIG. 38 shows an example of the arrangement of the base station according to the seventh embodiment. Note that the same reference numerals in FIG. 38 denote the same parts as in FIG. 18, and only differences will be explained. That is, a user assignment unit 1 in FIG. 38 multiplexes pilot signals to a signal addressed to each user. An OFDM transmitter unit 2 converts that signal to an OFDM signal to which the pilot signals are appended at the initial and terminal ends.

A DL OFDM user assignment unit 7 and UL FH user assignment unit 8 generate user assignment information and FH pattern information of each user on the basis of the transmission channel state information which is included in an FH signal received by an FH receiver unit 9 and is transmitted from each terminal.

An example of the arrangement of the terminal according to the seventh embodiment is the same as that in FIG. 19. Unlike in FIG. 19, the pilot signals at the initial and terminal ends of subcarrier signals received by an OFDM receiver unit 53 are used to estimate the transmission channel states in a transmission channel estimation unit 52. The transmission channel estimation unit 52 estimates the transmission channel states of all subcarriers using at least one of the pilot signals at the initial and terminal ends output from the OFDM receiver unit 53. For example, transmission channel state information indicating the estimation result of the transmission channel states using the pilot signal at the terminal end is output to an FH transmitter unit 51.

The OFDM receiver unit 53 demodulates the received signal on the basis of at least one of the pilot signals at the initial and terminal ends of the received OFDM signal. For example, the unit 53 demodulates the received signal on the basis of the pilot signal at the initial end of the received OFDM signal.

The FH transmitter unit 51 multiplexes data to be transmitted to the base station and the transmission channel state information output from the transmission channel estimation unit 52, and converts the multiplexed data into an FH signal using FH pattern information sent from the base station (obtained from the received signal by the OFDM receiver unit 53), thus transmitting the FH signal.

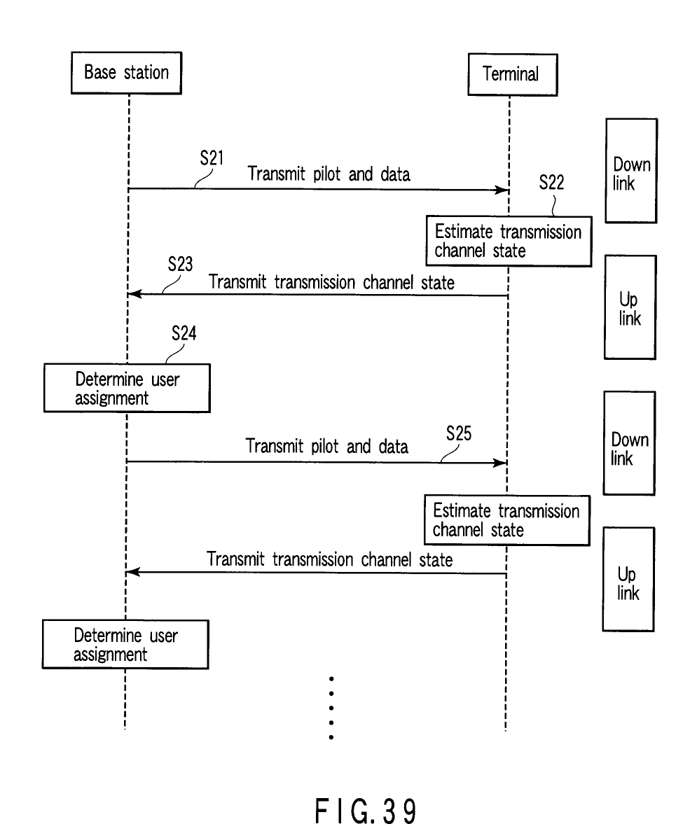

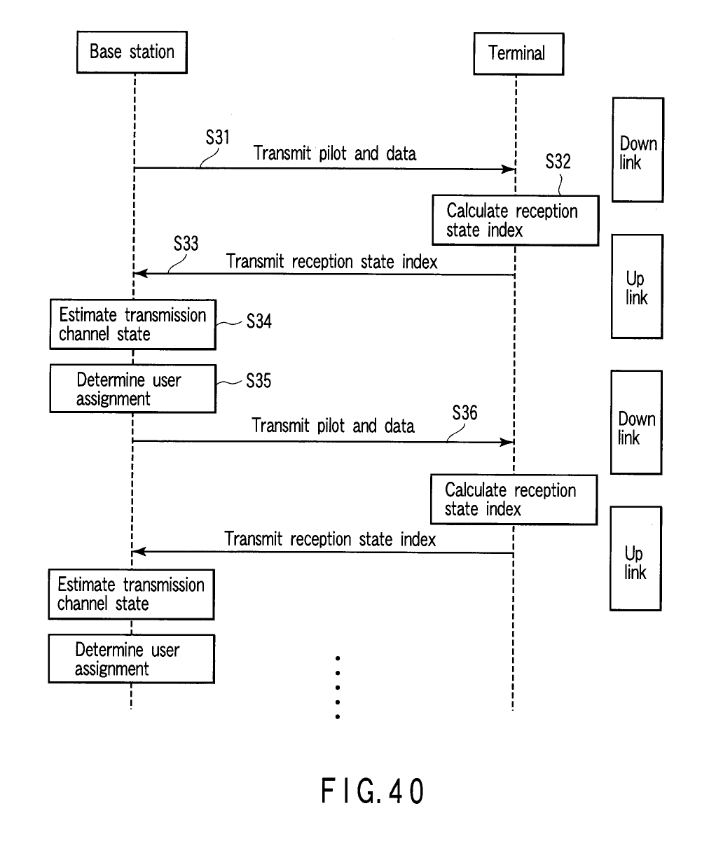

The control process between the base station and each terminal using initial and terminal symbols (the symbols are pilot signals known to the base station and each terminal) in a down slot in FIG. 37 will be described below with reference to the flowchart shown in FIG. 39.

In the down slot 201, the base station transmits a signal for N_DL symbols to each terminal using an OFDM signal (step S21). Of this signal, initial and terminal symbols are pilot signals known to the base station and terminal. Upon reception of the downstream OFDM signal, the terminal estimates the transmission channel states using the initial pilot signal using the transmission channel estimation unit 52 (step S22), and demodulates received data using the OFDM receiver unit 53. The estimation result (transmission channel state information) of the transmission channel states estimated using the pilot signal at the terminal end is fed back to the base station using an FH signal in the up slot 203 (step S23).

The base station can recognize the frequency bands with a good transmission channel state for each terminal on the basis of the transmission channel state information of that terminal, which is received from the terminal. Upon assigning subcarriers in a down slot 205 to each terminal, the base station preferentially assigns subcarriers of frequencies with a good transmission channel state for that terminal, and generates user assignment information. Upon determining a hopping pattern of an FH signal in the up slot 207 for each terminal, the base station determines a hopping pattern that mainly uses frequency bands with a good transmission channel state for that terminal, and generates FH pattern information of that user (step S24).

After user assignment is determined in this way, the base station appends initial and terminal pilot signals to an OFDM signal including subcarriers assigned to respective terminals so as to transmit data addressed to these terminals to the terminals, and transmits the OFDM signal to the terminals using the down slot 205 (step S25).

According to the seventh embodiment, since the peak average power can be reduced using the FH communication scheme in the up link, the power consumption of the terminal can be saved. Since the OFDM communication scheme is used in the down link, a high-speed downstream communication can be realized. Since the upstream and downstream communications are temporally multiplexed, each other's transmission channel characteristic estimation values can be used. Therefore, negotiation between the base station and terminal can be relatively easily made with a sufficient time margin.

Furthermore, according to the seventh embodiment, the transmission channel state is estimated using the pilot signal at the terminal end of an OFDM signal, which is transmitted in, e.g., the down slot 201. This estimation result of the transmission channel state is used by the base station upon assigning time and frequency bands to users in the down slot 205 and up slot 203 immediately after the down slot 201. Therefore, the base station can preferentially assign frequency bands, each of which is optimal (good transmission channel state) to one terminal, to that terminal on the basis of the transmission channel state at a timing close to the data transmission timing of the base station and terminal, thus reducing an error rate and improving the transmission efficiency.

### EIGHTH EMBODIMENT

In a radio communication system according to the eighth embodiment, pilot signals (as signals known to the base station and each terminal) are included at the initial and terminal ends of an OFDM signal to be transmitted in a down slot, as in the seventh embodiment. In the radio communication system according to the eighth embodiment, the terminal demodulates the OFDM signal using the pilot signal at the initial end of the OFDM signal, and calculates an index value of the reception state of the pilot signal using the pilot signal at the terminal end.

For example, the base station and each terminal store a table which is common to them and indicates phase information and amplitude information of the pilot signal at the terminal end. The terminal selects information closest to the state of the currently received pilot signal from those in the table. The terminal sets a value used to identify an address of the selected information in the tables as an index value corresponding to the reception state of the pilot signal. The index value (reception state index value) is fed back to the base station using an upstream FH signal.

The base station estimates the transmission channel state using the index value of the reception state in each terminal, which is received from that terminal. The base station preferentially assigns subcarriers with a good transmission channel state to each terminal using the estimated transmission channel state, and determines a hopping pattern that mainly uses frequency bands with a good transmission channel state.

The arrangement of the base station according to the eighth embodiment is substantially the same as that in FIG. 18, and only differences will be explained below. That is, an OFDM transmitter unit 2 multiplexes FH pattern information generated by an UL FH user assignment unit 8 and user assignment information generated by a DL OFDM user assignment unit 7 to data addressed to respective users output from a user assignment unit 1. Furthermore, the unit 2 appends pilot signals to the initial and terminal ends of the multiplexed data, thus converting the data into an OFDM signal.

A transmission channel estimation unit 6 stores a table that associates phase information, amplitude information, and index values (reception state index values) of the pilot signal at the terminal end. The unit 6 estimates the transmission channel states of subcarriers in each terminal using the reception state index value which is included in an FH signal received by an FH receiver unit 9 and is transmitted from that terminal. More specifically, the unit 6 acquires phase information and amplitude information of the pilot signal at the terminal end corresponding to the reception state index value from the table, and outputs the transmission channel estimation result based on them to the DL OFDM user assignment unit 7 and UL FH user assignment unit 8. The DL OFDM user assignment unit 7 determines user assignment in the next down slot on the basis of the transmission channel estimation result, and outputs user assignment information indicating that result. The UL FH user assignment unit 8 determines FH patterns of respective users in the next up slot, and outputs FH pattern information of respective users indicating that result.

An example of the arrangement of the terminal according to the eighth embodiment is the same as that in FIG. 19. Unlike in FIG. 19, a transmission channel estimation unit 52 stores a table that associates phase information, amplitude information, and index values (reception state index values) of the pilot signal at the terminal end. The terminal acquires an index value corresponding to the phase information and amplitude information of the pilot signal at the terminal end obtained by an OFDM receiver unit 53. This reception state index value is output to an FH transmitter unit 51. The FH transmitter unit 51 multiplexes data to be transmitted to the base station and the reception state index value output from the transmission channel estimation unit 52, and converts the multiplexed data into an FH signal using FH pattern information sent from the base station (obtained from the received signal by the OFDM receiver unit 53), thus transmitting the FH signal.

The processing operation between the base station and each terminal using a symbol (a pilot signal known to the base station and terminal) at the terminal end in a down slot in FIG. 37 will be described below with reference to the flowchart shown in FIG. 40.

In the down slot 201, the base station transmits a signal for N_DL symbols to each terminal using an OFDM signal (step S31). Of this signal, initial and terminal symbols are pilot signals known to the base station and terminal. Upon reception of the downstream OFDM signal, the terminal calculates an index value corresponding to the phase information and amplitude information of the received pilot signal at the terminal end using (step S32). This index value is fed back to the base station using an FH signal in the up slot 203 (step S33).

The base station estimates the transmission channel states of respective subcarriers in each terminal on the basis of the reception state index value received from that terminal (step S34). The base station determines user assignment in the next down slot on the basis of the transmission channel estimation result, and generates user assignment information indicating that result. Also, the base station determines FH patterns of respective users in the next up slot on the basis of the transmission channel estimation result, and generates FH pattern information of respective users indicating that result (step S35).

After user assignment is determined in this way, the base station appends initial and terminal pilot signals to an OFDM signal including subcarriers assigned to respective terminals so as to transmit data addressed to these terminals to the terminals, and transmits the OFDM signal to the terminals using the down slot 205 (step S36).

According to the eighth embodiment, since the peak average power can be reduced using the FH communication scheme in the up link, the power consumption of the terminal can be saved. Since the OFDM communication scheme is used in the down link, a high-speed downstream communication can be realized. Since the upstream and downstream communications are temporally multiplexed, each other's transmission channel characteristic estimation values can be used. Therefore, negotiation between the base station and terminal can be relatively easily made with a sufficient time margin.

Furthermore, according to the eighth embodiment, upon reception of an OFDM signal transmitted in, e.g., the down slot 201, the terminal calculates an index value indicating the reception state of the pilot state included at the terminal end of that OFDM signal. This index value is transmitted to the base station using the up slot 203. The base station uses this value upon estimating the transmission channel states of respective terminals. The base station assigns time and frequency bands to users in the down slot 205 and up slot 203 immediately after the down slot 201 on the basis of the transmission channel state estimation result. Therefore, the base station can preferentially assign frequency bands, each of which is optimal (good transmission channel state) to one terminal, to that terminal on the basis of the transmission channel state at a timing close to the data transmission timing of the base station and terminal, thus reducing an error rate and improving the transmission efficiency.

### NINTH EMBODIMENT

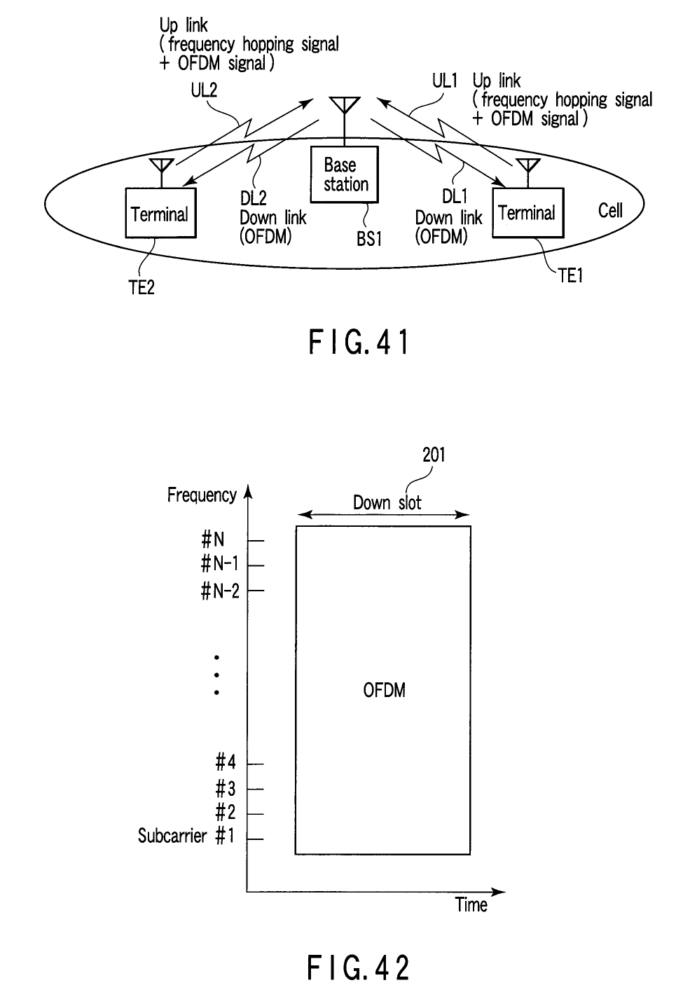

In a radio communication system according to the ninth embodiment, a base station BS1 and terminals TE1 and TE2 do OFDM communications using a plurality of subcarriers in a down link from the base station to the terminals, and communications using frequency hopping and OFDM in an up link from the terminals to the base station in a cell of a cellular communication network, and do TDD two-way communications, e.g., downstream and upstream communications, as shown in FIG. 41.

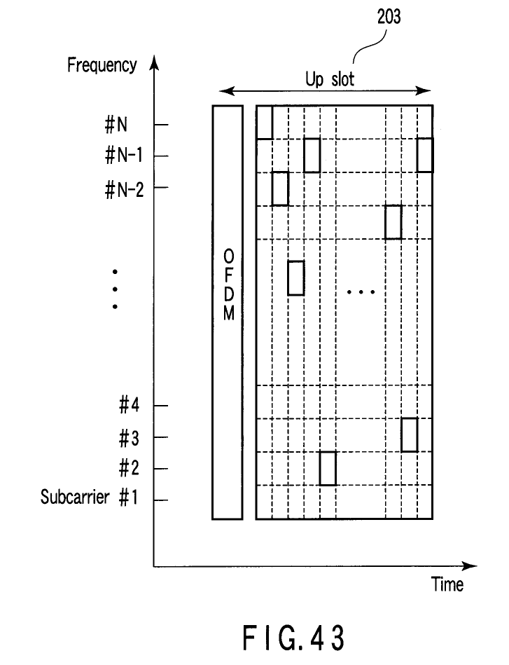

As shown in FIG. 42, in one down slot 201 of TDD, an OFDM communication is made using a plurality of subcarriers. On the other hand, in an up slot of TDD, a communication is done using frequency hopping and OFDM, as shown in FIG. 43. The transmission slot (communication time) of an OFDM signal in the up slot is shorter than that (communication time) of a frequency hopping (FH) signal, and each terminal transmits an OFDM signal for one symbol. An OFDM signal transmitted by each terminal in the up slot is used as a pilot signal used to measure reception quality, and is a symbol sequence known to the base station BS1 and terminals TE1 and TE2. In the following description, the OFDM signal transmitted by each terminal in the up slot is also called a known signal.

The known signal transmitted based on OFDM by each terminal in the up slot is used for measuring (estimating) the transmission quality of subcarriers on the base station side. The measurement result of the transmission quality is used in order to select subcarriers used in the down slot.

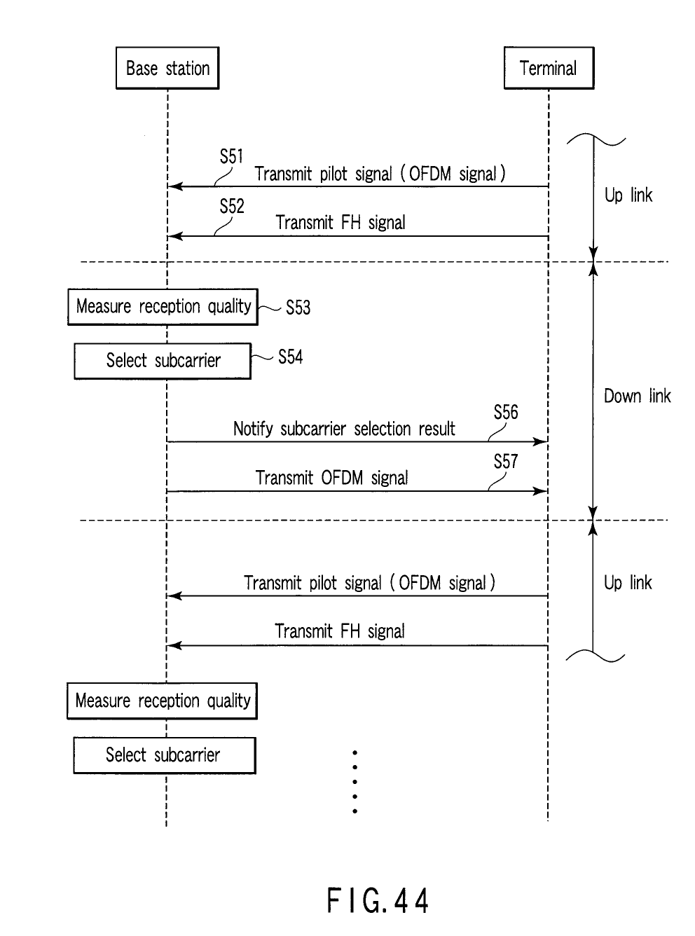

FIG. 44 is a flowchart for explaining the processing operation using the known signal between the base station and terminal in the communication system according to the ninth embodiment.

Each terminal transmits the known signal of OFDM signal in the up slot, as shown in FIG. 43 (step S51). After transmission of the known signal, the terminal transmits an FH signal (step S52). On the other hand, the base station demodulates the received OFDM signal, and measures the received power of all subcarriers from the sequence of the known signals, thus estimating the reception quality of subcarriers in respective terminals (step S53).

After measurement of the received power of subcarriers, the base station selects subcarriers used in communications with respective terminals in the subsequent down slot (step S54). For example, the base station preferentially selects subcarriers with high received power values from those which have received power values equal to or higher than a predetermined threshold value. The base station does not use subcarriers which have received power values less than the threshold values in communications with the terminals.

The base station transmits a signal that notifies the selected subcarriers to the terminals (step S56), and transmits transmission data addressed to these terminals using the selected subcarriers (step S57).

The method of assigning frequency-time regions (user channels) in the up and down slots to respective terminals will be described below.

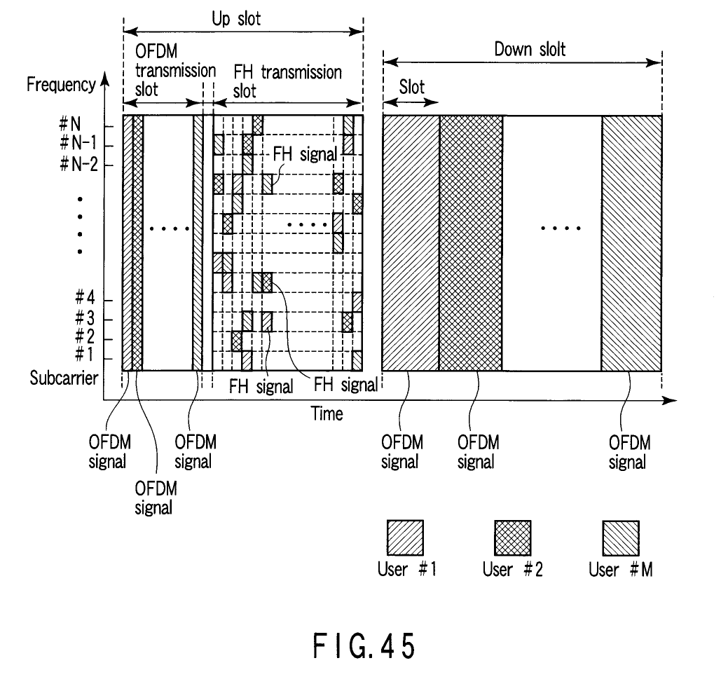

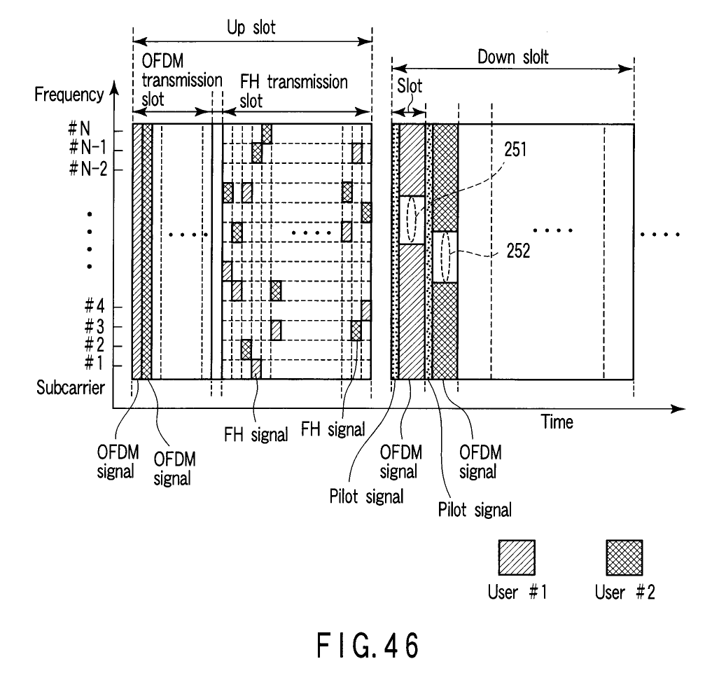

FIGS. 45 and 46 show the first assignment method. A slot (time slot) for an OFDM signal in the up and down slots is predetermined for each terminal. The base station determines, for each terminal, a frequency hopping pattern (e.g., by selecting frequency bands with high reception quality for that terminal) in a transmission slot of an FH signal in an up slot. The base station notifies each terminal of this frequency hopping pattern in advance.

In step S54, if it is determined based on the known signal transmitted from the terminal of user #1 that the reception quality in a frequency range 251 in a time slot assigned to user #1 in the down slot is low, as shown in FIG. 46, subcarriers in that frequency range 251 cease to be assigned to user #1. Likewise, if it is determined based on the known signal transmitted from the terminal of user #2 that the reception quality in a frequency range 252 in a time slot assigned to user #2 in the down slot is low, subcarriers in that frequency range 252 cease to be assigned to user #2.

In FIG. 46, each terminal is notified of subcarriers used in communications by the initial symbol of an OFDM signal transmitted from the base station in each slot assigned to that terminal in the down slot.

In this way, using a broadband signal transmitted from the terminal using the up slot, the base station can estimate the reception quality of all subcarriers. Since the base station preferentially uses subcarriers with high reception quality on the basis of the estimated reception quality of subcarriers, improvement of communication quality between the base station and each terminal can be expected.

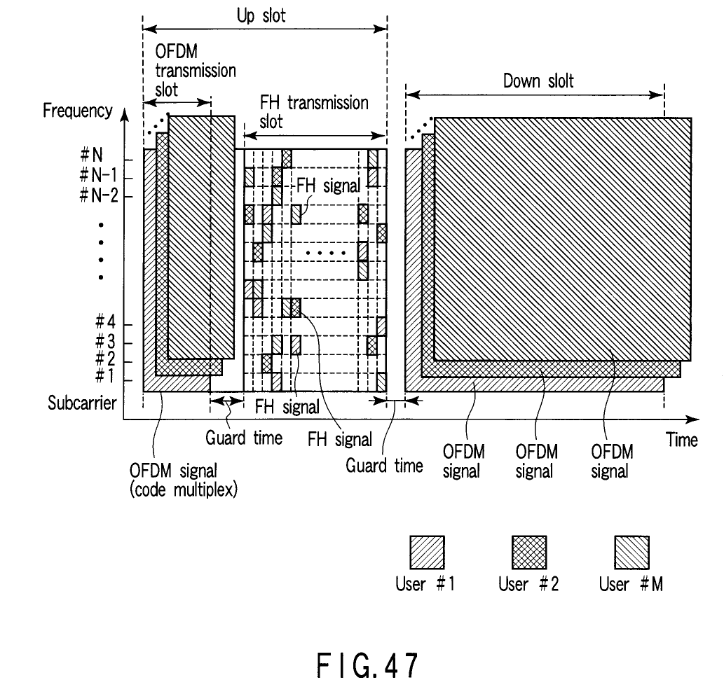

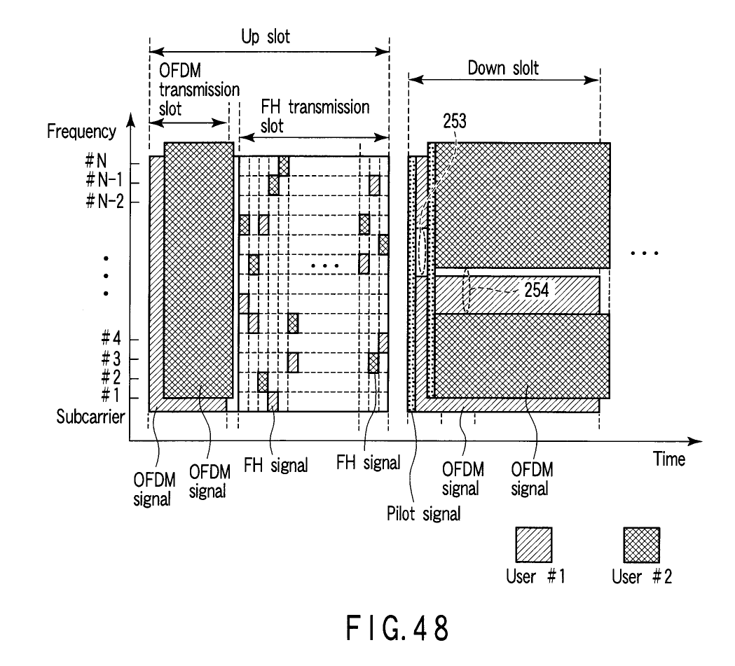

FIGS. 47 and 48 show the second assignment method. FIGS. 47 and 48 show a case wherein user multiplexing is done using spread codes assigned in advance to respective terminals in slots of OFDM signals in the up and down slots (OFCDM: Orthogonal Frequency and code division multiplex). The terminals do communications using spread codes designated by the base station. The base station determines, for each terminal, a frequency hopping pattern (e.g., by selecting frequency bands with high reception quality for that terminal) in a transmission slot of an FH signal in an up slot. The base station notifies each terminal of this frequency hopping pattern in advance.

In step S54, if it is determined based on the known signal transmitted from the terminal of user #1 that the reception quality in a frequency range 253 in a time slot assigned to user #1 in the down slot is low, as shown in FIG. 48, subcarriers in that frequency range 253 cease to be assigned to user #1. Likewise, if it is determined based on the known signal transmitted from the terminal of user #2 that the reception quality in a frequency range 254 in a time slot assigned to user #2 in the down slot is low, subcarriers in that frequency range 254 cease to be assigned to user #2.

In this way, using a broadband signal transmitted from the terminal using the up slot, the base station can estimate the reception quality of all subcarriers. Since the base station preferentially uses subcarriers with high reception quality on the basis of the estimated reception quality of subcarriers, improvement of communication quality between the base station and each terminal can be expected.

FIG. 49 shows an example of the arrangement of a transmission system of the terminal in the radio communication system according to the ninth embodiment. The same reference numerals in FIG. 49 denote the same parts as in FIG. 19, and only differences will be described. That is, in FIG. 49, an OFDM transmitter unit 88 used to transmit the known signal, and a storage unit 87 that stores a bit sequence of the known signal (known signal pattern) are newly added. Furthermore, the arrangement of a radio unit 58 is different from that in FIG. 19. Note that FIG. 49 shows the arrangement of the radio unit 58 in more detail than FIG. 19. Also, the arrangement of the terminal according to the ninth embodiment is substantially the same as that in FIG. 19, except for that of the transmission system shown in FIG. 49.

The radio unit 58 of the terminal in FIG. 19 includes a D/A converter 82 for converting an FH signal output from an FH transmitter unit 51 from a digital signal into an analog signal, a frequency converter 84 for making frequency conversion, and a power amplifier (PA) 86 for outputting a radio signal from an antenna. The radio unit 58 in FIG. 49 further includes a D/A converter 81 for converting an OFDM signal output from the OFDM transmitter unit 88 from a digital signal into an analog signal, a frequency converter 83 for making frequency converter, and a selector 85 for outputting one of the FH signal output from the frequency converter 84 and the OFDM signal output from the frequency converter 83 to the PA 86.

In general, in communications based on OFDM, since a signal having a flat frequency spectrum over a broad range is transmitted, the difference between the peak power and average power of a transmission time waveform becomes large, and the power consumption of the power amplifier (PA) of the transmission system poses a problem.

However, an OFDM signal transmitted in the up link is a known bit sequence used to estimate the transmission channel quality. Hence, a sequence that can reduce (minimize) the difference between the peak power and average power is examined in advance, and is stored in advance in the storage unit 87. Upon transmitting the known signal, the bit sequence stored in the storage unit 87 is read out, and undergoes encoding, subcarrier modulation, IFFT, and the like by the OFDM transmitter unit 88, thus transmitting the OFDM signal from the antenna via the radio unit 58. According to the arrangement shown in FIG. 49, the processes can be made using only one PA 86 without using two PAs for OFDM and frequency hopping.

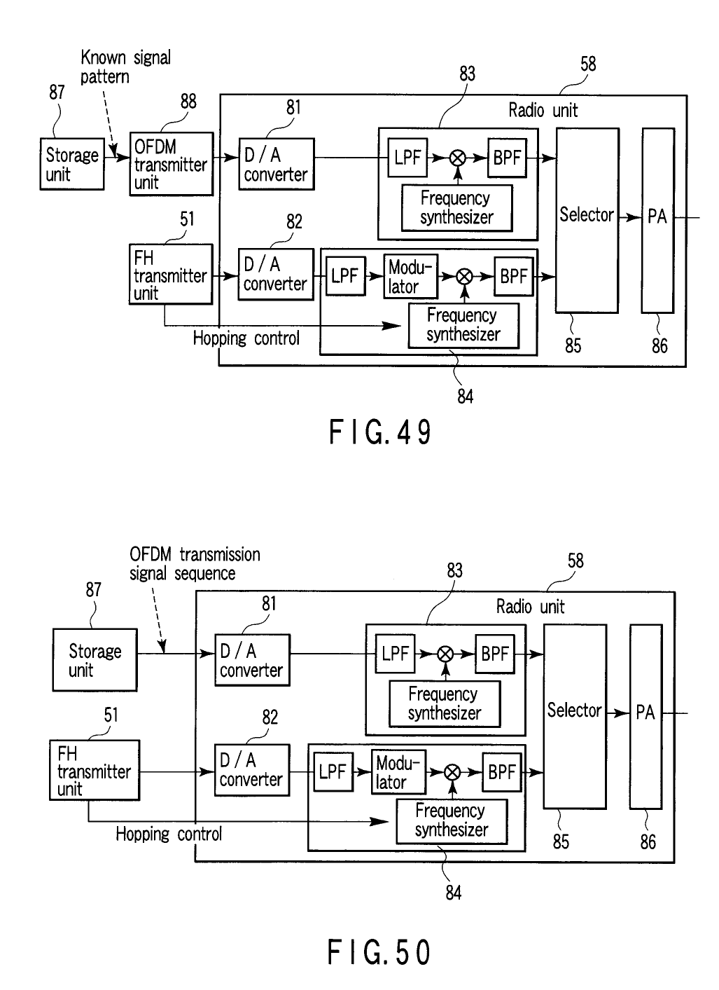

FIG. 50 shows another example of the arrangement of the transmission system of the terminal in the radio communication system according to the ninth embodiment. The same reference numerals in FIG. 50 denote the same parts as in FIG. 49, and only differences will be explained. That is, in FIG. 50 no OFDM transmitter unit 88 for transmitting the known signal is included, and the storage unit 87 stores a time waveform, after IFFT, of a bit sequence that can reduce the difference between the peak power and average power (to reduce PAPR (radio between the maximum power and average power)) in place of the bit sequence itself. Note that the arrangement of the terminal according to the ninth embodiment is substantially the same as that in FIG. 19, except for the arrangement of the transmission system shown in FIG. 50.

In case of the arrangement shown in FIG. 50, upon transmitting the known signal using the up link, the waveform stored in the storage unit 87 is read out, and undergoes D/A conversion and frequency conversion by the radio unit 58.

In this manner, the OFDM transmitter unit 88 required to convert the bit sequence into an OFDM signal is not required, thus realizing a size reduction and low power consumption of the terminal.

When frequency hopping is used in the up link, the frequency characteristics of all the frequency bands to be used cannot often be recognized depending on the selected hopping pattern. When subcarriers to be used in an upstream communication are selected in accordance with the reception state of a downstream communication, subcarriers which are not used do not transmit any signal, and the reception states of these subcarriers cannot be recognized.

However, according to the ninth embodiment, each terminal transmits a broadband signal across all the frequency bands to be used in the down time slot using a given time interval in the up time slot. The base station can measure the frequency characteristics of all the frequency bands by receiving this broadband signal. Using the broadband signal transmitted by the terminal in the up time slot, the base station can measure the frequency characteristics of all the frequency bands irrespective of the selected hopping pattern. Also, the base station can select subcarriers with good frequency characteristics in the down link to make communications. In this manner, the reception quality of the terminal can be improved.

The frequency hopping patterns used in the upstream communication are selected to be orthogonal for respective terminals. However, when respective terminals transmit the broadband signals to be transmitted using a given interval of the up time slot at the same time, the base station cannot normally receive them due to interference. Hence, the broadband signals are multiplexed by one of TDMA (Time Division Multiple Access) and CDMA (Code Division Multiple Access), thus avoiding interference upon reception of the broadband signals in the base station.

In OFDM, a large ratio between the peak signal power and average signal power (PAPR) often poses a problem depending on a signal sequence to be transmitted. However, since a sequence which is transmitted by the terminal for the purpose of measuring the frequency characteristics in the up link can be a known sequence, a sequence that can reduce the PAPR is selected in advance, thus eliminating the influence of nonlinear distortion in a power amplifier owing to the large PAPR.

Since the signal to be transmitted by the terminal using OFDM is a known sequence, a time waveform of a signal obtained by processing that sequence using an OFDM transmission circuit in advance is stored in advance. As a result, the OFDM transmission circuit can be omitted, and the signal process and circuit scale of the terminal can be reduced.

### 10TH EMBODIMENT

The 10th embodiment will explain an example of the processing sequence executed when a hopping pattern required for each terminal to make a communication with a base station in an up slot and channels required for the base station to make a communication with the terminal in the down slot in the radio communication system according to the first embodiment taking a radio communication system shown in FIG. 41 as an example.

As shown in FIG. 41, a base station BS1 and terminals TE1 and TE2 do OFDM communication using a plurality of subcarriers in a down link from the base station to the terminals, and communication using frequency hopping and OFDM in an up link from the terminals to the base station in a cell of a cellular communication network, and do TDD two-way communications, e.g., downstream and upstream communications.

The base station BS1 transmits information that notifies a hopping pattern, which can be used in the up link, toward a new terminal which enters a cover area, via a common channel of the down link.

The common channel is used to transmit common information to be sent from the base station to all terminals in the self area. Basically, even when signals are multiplexed, the terminal can immediately extract information using a known channel.

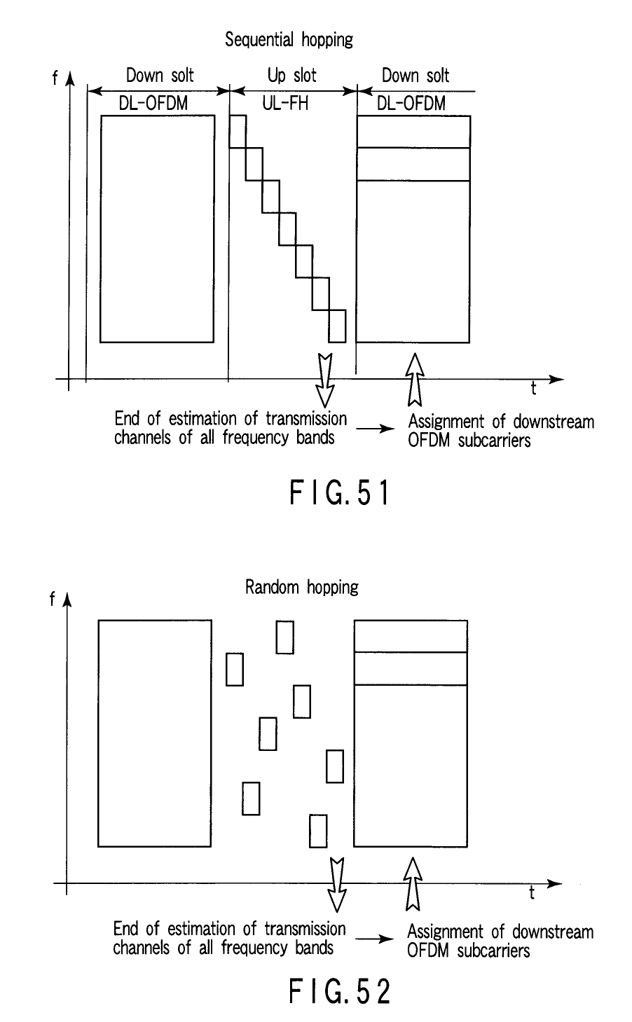

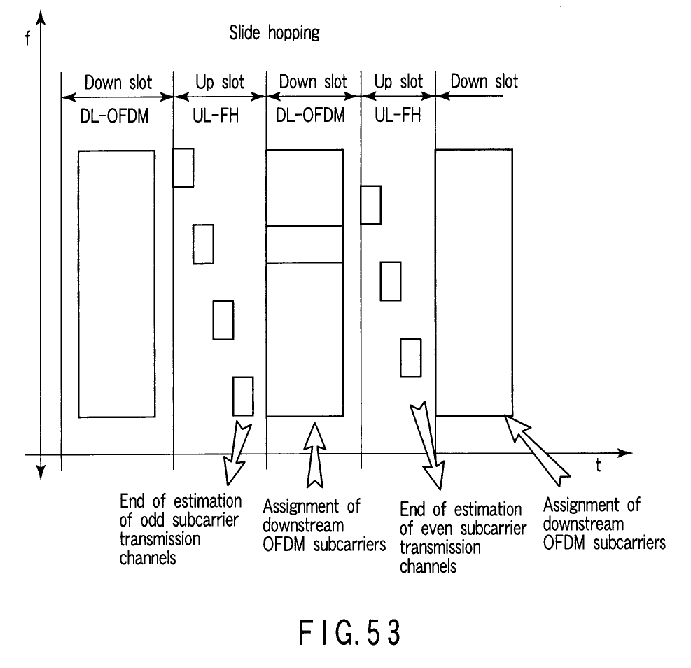

A hopping pattern is information that indicates the change order and timings of frequencies of transmission carriers in FH. In this case, assume that the hopping pattern uses all subcarriers. As the hopping pattern, a pattern that switches a subcarrier to neighboring one for each OFDM symbol (sequential hopping), as shown in FIG. 51, is available. Also, a pattern that hops subcarriers randomly, but does not transmit a subcarrier that has been transmitted once until all subcarriers are transmitted once (random hopping), as shown in FIG. 52, is available. Furthermore, a pattern that hops subcarriers while skipping neighboring ones (slide hopping), as shown in FIG. 53, is available.

Note that the arrangements of the base station and terminal according to the 10th embodiment are the same as those in FIGS. 18 and 19.

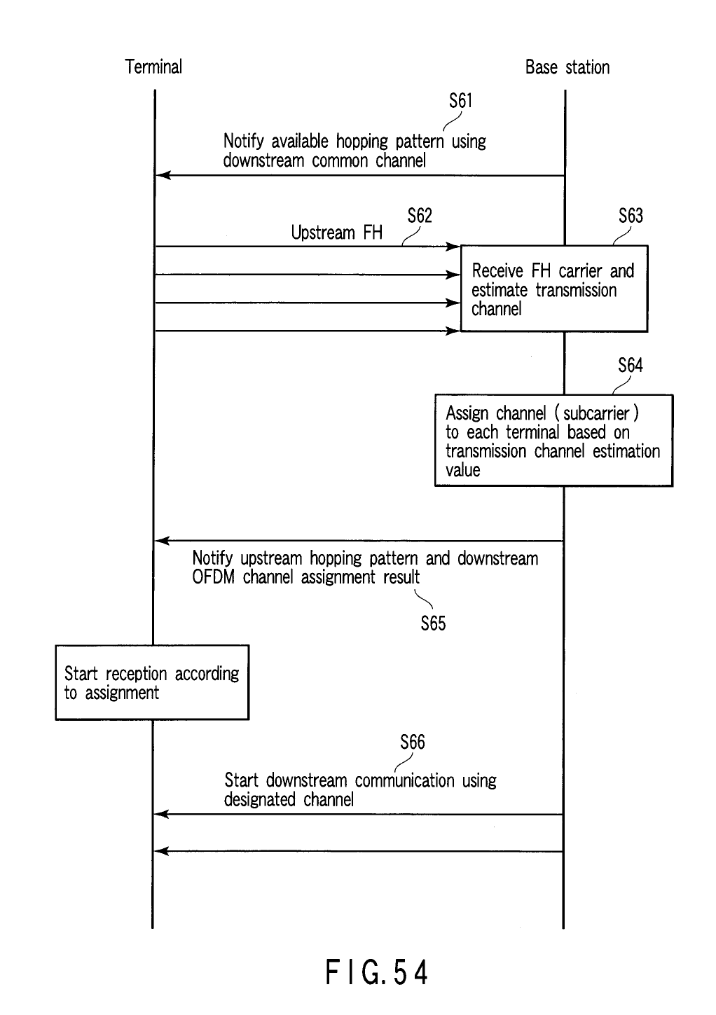

The processing operation executed when the base station assigns user channels in the down link using an FH signal transmitted from each terminal will be described below with reference to FIG. 54.

The base station transmits information of hopping patterns available in the up link via a predetermined common channel of the down link (step S61). Each terminal selects an arbitrary one of the available hopping patterns sent via the common channel, and transmits an FH signal to the base station (step S62). The base station (e.g., a transmission channel estimation unit 6) always receives and monitors available hopping patterns, and determines occurrence of transmission from a terminal upon detection of constant electric power or higher. The terminal transmits an FH signal with a hopping pattern that uses all subcarriers at least once within a predetermined period of time.

During transmission of FH signals using all subcarriers from respective terminals is completed, the transmission channel estimation unit 6 of the base station, which has detected transmission, performs transmission channel estimation using signals transmitted using the hopping pattern. A transmission channel estimation value is stored in a predetermined storage area of, e.g., the transmission channel estimation unit 6 (step S63). The transmission channel estimation value is a value obtained as follows: the receiving side receives pilot signals inserted in symbols as known signals transmitted from the terminal/base station, averages of values that is obtained by dividing each pilot signal received by a pilot signal component, then the distortions of the amplitude and phase of the transmission channel.

The base station stores transmission estimation values measured for FH transmission signals of communication terminals in the predetermined storage area of the transmission channel estimation unit 6 in addition to that of a new terminal which begins to transmit FH signals. The base station (a DL OFDM user assignment unit 7) updates channel assignment of a downstream OFDM signal on the basis of the transmission estimation values of respective terminals (step S64).

Each terminal is notified of a channel (e.g., one subcarrier in this case) assigned to that terminal using a predetermined common channel of the down link (step S65).

Upon reception of that notification, each terminal receives data transmitted from the base station via the channel of the down link which is assigned to that terminal (step S66).

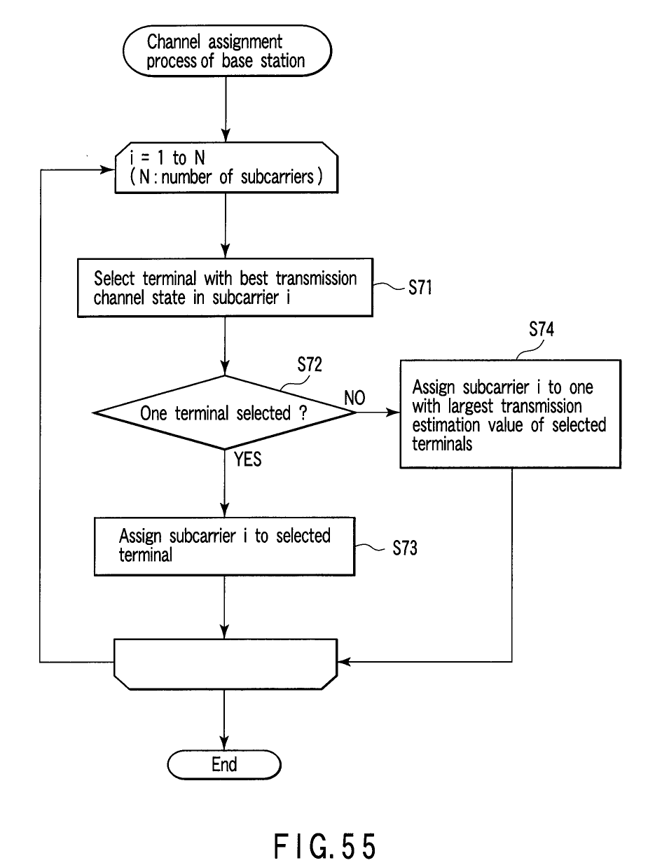

The channel assignment process in the DL OFDM user assignment unit 7 of the base station in step S64 will be described below with reference to FIG. 55. Assume that the channel assignment process is done for each subcarrier, and one subcarrier is used as a channel of one user.

One of all subcarriers (the total number of subcarriers is N) is selected. Let i be the selected subcarrier. On the basis of the transmission channel estimation values stored in the storage area of the transmission channel estimation unit 6, a terminal which has the best transmission channel state of subcarrier i is selected from those to which subcarriers are not assigned yet (step S71). If only one terminal is selected, subcarrier i is assigned to that terminal (steps S72 and S73). If a plurality of terminals are selected (step S72), subcarrier i is assigned to one, which has the largest transmission channel estimation value, of the plurality of terminals (step S74). The processes in steps S71 to S74 are repeated until subcarriers are assigned to all terminals in the area.

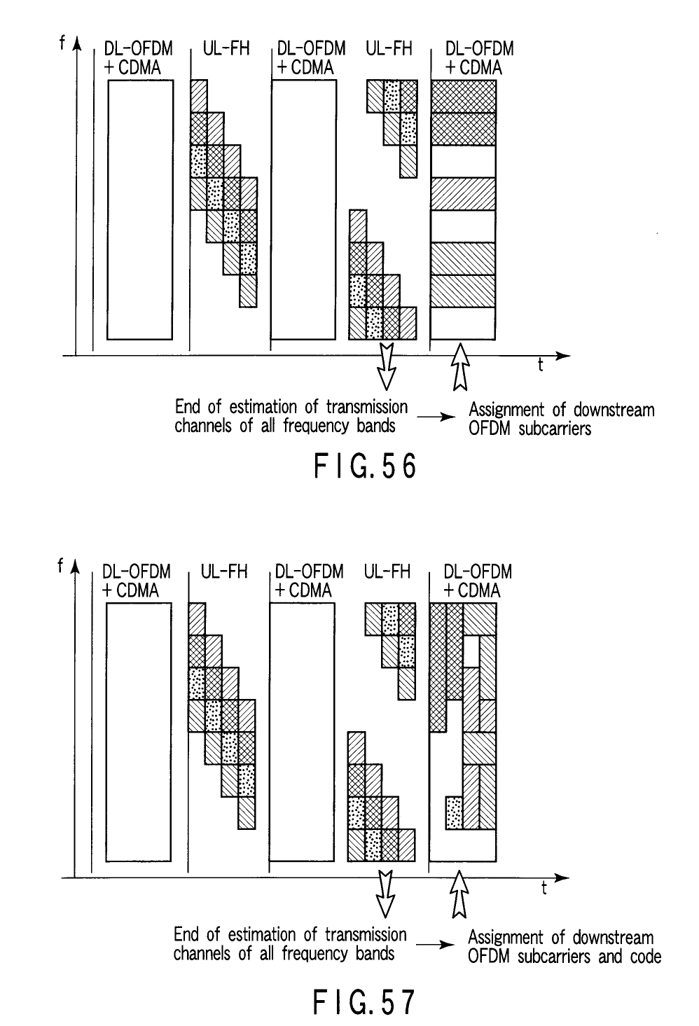

FIG. 56 shows the processes executed until channels in the down link are assigned to respective terminals using FH signals transmitted from the terminals.

According to the 10th embodiment, efficient channel assignment can be made with few processing steps.

### 11TH EMBODIMENT

The 11th embodiment will explain a case wherein a plurality of user channels are multiplexed on one subcarrier in the down link in the radio communication system according to the 10th embodiment. As a method of multiplexing a plurality of channels on one subcarrier, CDMA or TDMA may be used, or a combination of CDMA and TDMA may be used. Differences from the 10th embodiment will be described below.

An example of the arrangement of the terminal according to the 11th embodiment is substantially the same as that shown in FIG. 19, except for the processing operation of a user signal extraction unit 54. That is, the user signal extraction unit 54 extracts only a symbol addressed to the self terminal from a broadband signal (a plurality of subcarrier signals) output from an OFDM receiver unit 53, and outputs that symbol to a signal separation unit 55. For example, when signals are multiplexed by CDMA, user assignment information includes a spread code assigned to the self terminal or information required to specify that spread code. The user signal extraction unit 54 performs a despread process using that spread code. Other operations are the same as those in the first embodiment.

An example of the arrangement of the base station according to the 11th embodiment is substantially the same as that shown in FIG. 18, except for the processing operation of a user assignment unit 1. That is, the user assignment unit 1 multiplexes a plurality of user channels on one subcarrier. For example, when CDMA is used, the unit 1 executes a spread process using a spread code which is determined in advance for each terminal.

Multiplexing is done using an OFDM symbol as a minimum unit. When CDMA is used to multiplex a plurality of user channels on one subcarrier, a chip generated by spreading one data by a spread code is transmitted as an OFDM symbol. Such chips can be arranged in the frequency or time axis direction, and the receiving side can decode the spread code by despreading chips collected by a user signal extraction unit 10.

In this manner, when a plurality of channels are assigned to one subcarrier, an OFDM signal in the down link can accommodate more user channels.

In practice, when an OFDM symbol is assigned to each terminal as a channel, the number of OFDM symbols required per down slot (the number of OFDM symbols included in one user channel) is calculated based on the required transmission rate of the terminal.

Hence, in the 11th embodiment, the following processing operation is made in step S64 in FIG. 54 to make channel assignment.

For a given terminal, OFDM symbols are assigned one by one to subcarriers in turn from those which have higher ones of the transmission channel estimation values for respective subcarriers of terminals that belong to the area of the base station. At this time, a channel is not assigned to a subcarrier whose transmission channel estimation value is less than a predetermined threshold value (with poor transmission channel state). In this manner, a required number of OFDM symbols per user channel are assigned to each terminal while preferentially selecting subcarriers with higher transmission channel estimation values for respective subcarriers of that terminal.

FIG. 57 shows the processes executed until channels in the down link are assigned to respective terminals using FH signals transmitted from the terminals.

According to the 11th embodiment, channel assignment can be made more efficiently than the 10th embodiment.

What is claimed is:

1. A radio communication system which includes a base station apparatus and terminal apparatuses and performs TDD (Time Division Duplex) two-way communications using an OFDM (Orthogonal Frequency Division Multiplexing) signal including all or some of a plurality of subcarriers in a downstream communication from a base station apparatus to each of the terminal apparatuses, and an FH (Frequency Hopping) signal having the same frequency band as that of the subcarriers in an upstream communication from the each of the terminal apparatuses to the base station apparatus,
the base station apparatus comprises:
an estimation unit configured to estimate transmission channel characteristics between the each of the terminal apparatuses and the base station apparatus based on a signal transmitted from the terminal apparatus using a time slot of the upstream communication; and
an assignment unit configured to assign, to the each of the terminal apparatus, at least one of subcarriers to be used in the downstream communication of the subcarriers and a hopping pattern to be used in the downstream communication.

2. A system according to claim 1, wherein the each of the terminal apparatuses comprises a transmitter unit configured to transmit a known signal between the base station apparatus and the each of the terminal apparatuses to the base station apparatus using the OFDM signal in a partial time period in the time slot of the upstream communication, and transmits the FH signal to the base station apparatus within a remaining time period except for the partial time period in the time slot of the upstream communication, and
the estimation unit of the base station apparatus estimates transmission channel characteristics of the subcarriers based on the OFDM signal transmitted from the each of the terminal apparatuses in the time slot of the upstream communication.

3. A system according to claim 2, wherein OFDM signals transmitted from respective terminal apparatuses are multiplexed in the partial time period by one of TDMA (Time Division Multiple Access) and CDMA (Code Division Multiple Access).

4. A system according to claim 2, wherein the known signal is a bit sequence which minimizes a ratio between an average signal power value and peak signal power value.

5. A base station apparatus which performs TDD (Time Division Duplex) two-way communications using an OFDM (Orthogonal Frequency Division Multiplexing) signal including all or some of a plurality of subcarriers in a downstream communication to a terminal apparatus, and an FH (Frequency Hopping) signal having the same frequency band as that of the subcarriers in an upstream communication from the terminal apparatus, the base station apparatus comprising:
an estimation unit configured to estimate transmission channel characteristics between the terminal apparatus and the base station apparatus based on a signal transmitted from the terminal apparatus using a time slot of the upstream communication; and
an assignment unit configured to assign, to the terminal apparatus, at least one of subcarriers to be used in the downstream communication of the subcarriers, and a hopping pattern to be used in the downstream communication.
